(19) United States
(12) Patent Application Publication
(10) Pub. No.: US 2009/0081430 A1
(43) Pub. Date: Mar. 26, 2009

(54) Transparent Adhesive Tape

(75) Inventors: Marc Husemann, Hamburg (DE); Gabriel Dalmis, Hamburg (DE)

Correspondence Address: NORRIS, MCLAUGHLIN & MARCUS, 875 THIRD AVE, 18TH FLOOR, NEW YORK, NY, 10022, US

(73) Assignee: TESA AKTIENGESELLSCHAFT, Hamburg (DE)

(21) Appl. No.: 12/190,268

(22) Filed: Aug. 12, 2008

(30) Foreign Application Priority Data
Sep. 20, 2007 (DE) 10 2007 045 168.9

(51) Int. Cl. B32B 7/02

(52) U.S. Cl. 428/212

(57) ABSTRACT

A construction is presented for a unilaterally bondable, high-transparency, substantially two-dimensional element (2D element) having a support and an adhesive, which is used as a shatterproofing device for brittle 2D bodies.

### BACKGROUND OF THE INVENTION

(1) Field of the Invention

The invention is situated within the field of applied polymer engineering and relates to an exclusively unilaterally bondable, substantially two-dimensional element (2D element) comprising a sheetlike first functional layer, a sheetlike second functional layer and a sheetlike adhesive coating, one of the two functional layers being designed as a support and the other of the two functional layers being designed as an adapter, the second functional layer having, parallel to its principal extent, first and second side faces, the first functional layer being disposed on the first side face of the second functional layer, and the adhesive coating being disposed on the second side face of the second functional layer and being adapted for permanent joining of the 2D element to a brittle 2D body which is to be held together by means of the 2D element in the event of fracture. The invention further relates to an adhesively bonded assembly comprising a 2D element of this kind and a see-through element, and also to a display system having an adhesively bonded assembly of this kind and a display device. The invention relates, finally, to the use of a 2D element as a shatterproofing device for a brittle 2D body, which holds the 2D body at least substantially together in the event of fracture of the 2D body and so acts against separation of fragments of the 2D body, and also the use of an adhesively bonded assembly as a damage protection device for a display device in a display system, which acts against damage to the display device in the event of external mechanical influence.

(2) Description of Related Art

Virtually all devices in modern entertainment electronics have visual display systems to display the operational status of the device, or further information. Where the interrelationships to be depicted are relatively complex, display frequently takes place using display modules on the basis of liquid crystals (LCD) or of organic light-emitting diodes (OLED). Displays of this kind are employed, for instance, in digital cameras, portable handheld computers and mobile telephones.

In order to protect the display modules from any damage from external mechanical influences such as impact, for example, display systems of this kind typically have transparent protective windows which cover the outside of the display modules and so reduce the risk of the module being influenced directly. Such protection is likewise necessary in the case of non-electronic visual display systems, as in the case of mechanical displays such as clocks or level displays on storage vessels, for example.

Protective windows used are typically polymer screens or glass screens, with each of the two systems having its pros and cons and therefore requiring selection according to the specific application.

Hence polymer screens are inexpensive, easy to process, and offer efficient protection from mechanical influences, but have the drawback that they are typically not scratch-resistant and are therefore easily damaged. After just a short time this not only results in a deterioration in the aesthetic impression of the display systems but also has the consequence, furthermore, of a reduced view of the display area of the display modules. Moreover, many common polymers have only limited resistance to ultra-violet light (UV light) or to organic solvents.

Glass protective windows, on the other hand, are inert towards organic solvents and in view of their great hardness are also scratch-resistant, giving them a high-quality impression. Owing to the brittleness of this material, resulting from its hardness, however, glass is of only limited suitability as a protection against mechanical influences such as impact or strike, since even weak stresses may be accompanied by fragmentary brittle fracture of the glass screen. As well as the limited protection effect, therefore, there is a risk of injury from the shards that are produced, and also the risk of damage to the display module by sharp-edged fragments.

In order to reduce the consequences of a glass fracture of this kind, many systems use laminated glass, which is composed of individual glass sheets bonded to one another over their full area and disposed one above the other. For structural reinforcement, laminated glasses also frequently feature films made from polymers such as polyvinylbutyral, for instance, between the glass sheets within the bond. The overall composite system formed is therefore an (at least) three-ply system. Although in principle there may be fracture of the individual glass sheets even in the case of a glass laminate of this kind, the bonding of the glass sheets to one another (and also, where appropriate, of the intermediate films) reduces the risk of detachment of the fragments from the laminate and so acts against splintering.

For non-stationary applications, however, laminated glass of this kind is a disadvantage on account of its high weight and relatively expensive manufacture. As a protective window it is therefore common to use a laminate of a single sheet of glass with an adhesive film. This adhesive film is composed of a stable support comprising a polymer film, which on one side has an adhesive via which the support is joined to the glass sheet. The laminated protective window obtained in this way possesses, accordingly, a scratch-resistant side with a surface of glass, and a side with the polymer film as its surface.

On installation into the display system, the laminated protective window is fastened with the scratch-resistant glass side facing outwards in the system, so that the side with the more easily damaged polymer film is facing inwards and hence towards the display module. With this arrangement of the asymmetrically constructed laminate it is possible to prevent scratching of the surface of the protective window when the device incorporating the display system is in frequent use.

A laminated protective window of this kind, however, is not fully transparent, but instead typically contains defects which reduce the intensity of the light passing through the protective window. Even when materials which do not have any absorption in the visible region of the spectrum of light are used, there are reflections at the surface of the protective window that result in a reduction in transmittance. This represents a problem more particularly in the case of low-contrast displays, since the viewer is then unable to make out adequately the information reproduced on the display array, owing to the low light intensity. This is the case, for instance, with all of those display systems which are employed in inadequately darkened environments—as, for example, portable handheld computers outdoors under direct sunlight—and also in the case of display systems which for technical reasons have only a low contrast, examples being liquid-crystal displays with low energy consumption which do not have any self-illuminating backlight elements but instead exclusively reflect the ambient light incident from their exterior.

### BRIEF SUMMARY OF THE INVENTION

It is an object of the present invention, therefore, to provide an exclusively unilaterally bondable, substantially two-dimensional element that eliminates these drawbacks, which can be employed more particularly as a cost-effective, high-transparency functional film in the production of transparent laminated protective windows of variable form, and so permits simple production of display systems with a transparent sightpath.

This object is achieved in accordance with the invention by a device of the type specified at the outset, in which the first functional layer has a refractive index nd(20° C.) from a range from 1.20 to 1.40, preferably from a range from 1.23 to 1.37, the second functional layer has a refractive index nd(20° C.) from a range from 1.48 to 1.60, more preferably from a range from 1.53 to 1.59, and the adhesive coating has a refractive index nd(20° C.) from a range from at least 1.43 to 1.60, preferably from a range from 1.47 to 1.58, more preferably from a range from 1.47 to 1.50.

Contributing to the invention to a particular extent is the specific three-dimensional sequence of the individual layers, taking account of the functionality to be achieved by means of each of these layers. The inventive effect derives more particularly from the relative arrangement of the materials whose refractive indices are specified.

The general approach for improving the transparency of a body is to increase the fraction of the transmitted light and to minimize the occurrence of any competing processes. Transparent bodies have a high transmittance, which is a little less than 1 (corresponding to transmission of 100% of the incident light). For light of a defined wavelength λ, the law of conservation of energy meant that, in the absence of processes generating light, the intensity of the light passing through a body corresponds to the intensity of the incident light less the intensity of the light absorbed by the body and the intensity of the light reflected at the boundary faces of the body. Accordingly, for optical components which are designed for transmission, the competing processes, whose occurrence must be reduced, are light absorption and light reflection.

As measurements with a UV-Vis spectrophotometer show, glasses and polymers based on acrylate copolymer and acrylate block copolymer, for example, generally have only low absorption in the visible region of light (in the wavelength range between 400 nm and 700 nm). When optimizing systems of this kind, therefore, account must be taken primarily of the reflection component.

Reflection occurs at the boundary face between two phases 1 and 2 which are in contact with one another. The extent of this reflection is dependent on the refractive indices nd,1 and nd,2 of the two materials.

For the purposes of the present study, the refractive index nd means the parameter defined according to Snell's law of diffraction. The value of the refractive index depends overall on the wavelength of the incident light and on the temperature of measurement. Unless specified otherwise, the refractive index nd is interpreted here as that value which is measured at a temperature of 20° C. with light having a wavelength of 550 nm (±150 nm).

Calculation using the refractive indices nd,1 and nd,2 of the two materials in contact with one another at the boundary face gives the reflection p(λ) in accordance with the Fresnel equation as follows:

$$ρ ( λ ) = {( \frac{{n}_{d , 2} - {n}_{d , 1}}{{n}_{d , 2} + {n}_{d , 1}} )}^{2} .$$

For the case of materials having the same refractive index (isorefractive materials, in other words where nd,1=nd,2), the denominator in the above equation takes on a value of zero. At this boundary face therefore, there is no reflection. A value of this kind is rarely achieved in practice, however, since the materials in contact with one another generally have different refractive indices and, therefore, the refractive index of the system alters in a sharp transition at the phase boundary.

In order to reduce the reflection occurring at the boundary face, therefore, it is possible to provide at the boundary face an additional material whose refractive index lies between the refractive index of the one phase and the refractive index of the other phase, with the consequence that, instead of a large change at the original boundary face, there are two smaller changes at the two intermediate boundary faces produced by incorporation of the material. The additional material in this system serves as an adapter in relation to the refractive indices of the two phases, and therefore fulfils the function of an antireflection means.

In the case of a particularly large change in the refractive index at the boundary face, or in order to obtain particularly small reflection losses, the antireflection means may also be of multi-ply construction, thereby being composed of a plurality of individual plies, and, if the materials are precisely matched, the changes in the refractive indices at each of the intermediate boundary faces can be particularly small.

Where, for example, one phase of the boundary face consists of air, with a refractive index nd of 1.00, and the other phase consists of glass, with a refractive index nd from a range from about 1.45 to 1.65 (depending on composition; for example, for quartz glass (nd: 1.458), borosilicate crown glass (nd: 1.518), borosilicate crown glass BK7 (nd: 1.514), flint glass (nd: 1.620); values in each case for light with a wavelength of 588 nm; according to Pedrotti, Pedrotti, Bausch, Schmidt, Optik, 1996, Prentice Hall, Munich), the antireflection means used may have, for example, a refractive index nd of 1.20.

Where reflection losses at the boundary face of two phases are to be minimized through the use of multi-ply systems, it is absolutely necessary, therefore, on transition from the one phase via the multi-ply system to the other phase, for the three-dimensional sequence of the individual plies to be such that there is a continuous rise (or fall) in the refractive indices.

It has now been found, however, that, in contrast to a continuously rising arrangement of the refractive indices of this kind, particularly transparent laminate systems are obtained when an inventive 2D element of this kind has been adhered to a glass plate used as a see-through element, the refractive index of the second functional layer of said 2D element being higher than the refractive index of the adhesive coating and significantly higher than the refractive index of the first functional layer.

If, therefore, the 2D element of the invention had a layer sequence in which the refractive index of the adhesive coating was lower than in the case of a sequence having refractive indices rising continuously from the first functional layer via the second functional layer and onto the adhesive coating, the 2D laminate obtained therewith has a particularly high transmittance. The inventors attribute this improvement in transmittance to a high-quality, and therefore superior, adhesive bond between the glass substrate and the adhesive coating, which can be achieved preferentially when using adhesives having lower refractive indices than actually necessary. On account of the improved adhesive bond, it is thought that a more homogeneous bond area is formed than in the case of conventional systems, with the consequence that, after adhesive bonding has taken place, the concentration of centres of scattering per unit area is lower.

In this context it is favourable, moreover, if the 2D element is designed so as to be very highly transparent for visible light over its full area, having a transmittance, for light with a wavelength of 550 nm, of more than 86%, more particularly more than 88% and more preferably more than 92%. As a result of a design of very high transparency of this kind, it becomes possible more particularly to use the 2D element of the invention for particularly low-contrast display systems as well.

Within a 2D element of the invention it is possible, for instance, for the first functional layer to be designed as a support and, accordingly, for the second functional layer to be designed as an adapter. In this way the support is not exposed at any of the side faces of the 2D element, and so, more particularly when using mechanically robust adapters, a 2D element is provided which is protected from damage as a consequence of external mechanical influence, such as from scratching during manufacture. Alternatively it is also possible for the first functional layer to be designed as the adapter and for the second functional layer to be designed as the support. In this way it is also possible to employ suitable support materials having a low refractive index in the 2D element of the invention.

It is advantageous if the adapter is an antireflection means set up to reduce the fraction of visible light reflected at the outside of the 2D element. In this way it is possible to increase the fraction of transmitted light and so to improve the transparency of the 2D element. It is particularly advantageous if the antireflection means has a multi-ply construction. A multi-ply construction of this kind allows controlled, fine-tuned adaptation of the refractive indices to be carried out and hence the reflection losses to be kept particularly small. Instead, however the antireflection means can also have a single-ply construction, i.e. may consist only of a single ply, with the consequence that it is possible to use an antireflection means having a homogeneous coherence and so to increase its mechanical robustness. In this case it is advantageous more particularly if the antireflection means is an antireflection coating having a coat thickness of at least 0.2 nm and not more than 500 nm, preferably having a coat thickness of at least 1.0 nm and not more than 50 nm. In this way the antireflection means can be made particularly compact and at the same time have high mechanical flexibility.

It is advantageous, furthermore, if at least the first functional layer is designed so as to be stable towards mechanical stress. This encompasses, for example, a high strength such as tensile strength, for instance, high tear strength, low scratchability, low splittability or the like. As a result of this design of the outwardly directed side face of the 2D element, damage to the 2D element, especially during manufacture of the display system, is prevented and hence a high transparency is ensured.

It is advantageous if the adhesive coating comprises a pressure-sensitive adhesive. This allows the 2D element to be bonded simply on the brittle 2D body.

It is advantageous, finally, for the 2D element to comprise a temporary support which is disposed on the adhesive coating and is joined residue-lessly detachably to the adhesive coating. This design allows particularly simple handling of the 2D element of the invention prior to bonding on a see-through element. More particularly this design allows dust-free and bubble-free adhesive bonds to be obtained and hence also an adhesive bond with outstanding transparency.

According to a further aspect of the present invention there are proposals for the use of one of the above-stated 2D elements as a shatterproofing device for a brittle 2D body, which, in the event of fracture of the 2D body, holds the 2D body at least substantially together and so acts against separation of fragments of the 2D body, and also for an adhesively bonded assembly obtained from one of the aforementioned 2D elements and a see-through element, in which the see-through element is permanently joined to the 2D element via the adhesive coating of the 2D element.

It is particularly advantageous in this case if the see-through element has at least one glass portion which as a brittle 2D body is adapted for joining to the 2D element. On account of the high optical quality and transparency of this material and also the high scratch resistance, the use of glass results in a particularly stable and, at the same time, transparent adhesive bond.

Furthermore, in accordance with a further aspect, the invention affords the use of this adhesively bonded assembly as a damage protection device for a display device. The damage protection device acts against damage to the display device in the event of external mechanical influence. As a result, a display system having this adhesively bonded assembly and a display device is provided in which the adhesively bonded assembly is disposed such that the side of the adhesively bonded assembly on which the 2D element is disposed faces the side of the display device which is adapted for the display of the information to be displayed. As a consequence of this arrangement, a display system is obtained which is scratch-resistant on its outside in the optical display region.

It is advantageous in this case if the 2D element and the side of the display device that is adapted for the display of information are disposed at a distance from one another such that the average distance is at least 40 μm and not more than 510 μm, more particularly at least 50 μm and not more than 400 μm. This produces effective mechanical decoupling of the surfaces of the two components in combination with high transparency, with the consequence that the assembly with the 2D element does not come into contact with the display device even in the event of deformation—as a result, for instance, of a mechanical pressure exerted on the see-through element—and so makes it possible to avoid damage to the display device even in the event of severe external influence.

Substantially two-dimensional elements (2D elements) according to the invention are all customary sheetlike structures which permit adhesive bonding. They may be of various designs, being more particularly flexible, in the form of a tape, label or film, for example. On account of the sheetlike design, therefore, 2D elements extend along their length and width (principal extent) in each case over an area which is greater than the extent of the 2D element in a direction perpendicular to these two directions (height; secondary extent), it being possible for the areal extent to be situated in one plane or, as on a curved substrate, for instance, in a non-planar arrangement. Bondable 2D elements are 2D elements which are bonded and then offer a mechanically robust join to the bond substrate. For this purpose the bondable 2D elements are provided unilaterally with adhesive, which is disposed likewise in sheetlike manner in the form of an adhesive coating.

2D elements of this kind are, in the present case, highly transparent to visible light and may even be of ultra-high transparency design, thereby preferably having a transmittance of more than 86% for light with a wavelength of 550 nm, more particularly of more than 88% and more preferably of more than 92%. Transparency of this kind is achieved through the selection of suitable materials as components of the 2D element, a selection in this respect being made, for instance, in the context of low absorption for materials in the desired wavelength range and also in terms of the respective refractive index. Examples of systems of this kind are described below.

The 2D element has a first functional layer and a second functional layer. Functional layers for the present purposes are all structures of sheetlike arrangement that are provided within the overall system primarily for the purpose of obtaining a functionally uniform effect, which may hence also serve for a more precise description of the functional layer. The uniform effect within a functional layer of this kind may also, however, be achieved via individual sub-processes, such as in a functional layer of multi-ply construction, in other words a functional layer which is constructed in turn from at least two individual plies which are different in terms of their chemical, structural and/or geometric construction.

In the present case, the second functional layer, parallel to its principal extent, has first and second side faces, the first functional layer being disposed on the first side face and the adhesive coating being disposed on the second side face, with the consequence that the second functional layer is located between the first functional layer and the adhesive coating.

In accordance with the invention, one of the two functional layers is designed as a support and the other of the two functional layers is designed as an adapter. This support is designed in sheetlike manner with a two-dimensional principal extent. In parallel to its principal extent the support is bounded by two side faces, a first side face and a second side face.

The support may be produced from any suitable materials spread out in sheetlike form, subject to the proviso that these materials have a high transmittance in the wavelength range of visible light. Hence it is of advantage if the transmittance for light with a wavelength of 550 nm is more than 86%, more preferably more than 88%. It is advantageous, moreover, if the haze is less than 1% (determined in accordance with ASTM D 1003).

Apart from the selection of the support material in accordance with its optical properties, the support ought to have sufficient strength to be able to ensure protection with respect to splinter-like fragments of the substrate. For this purpose it is advantageous if the support withstands a tensile stress of more than 50 MPa (determined in accordance with ASTM D882), preferably even 150 MPa, a level which can be obtained, for example, through the use of polyethylene terephthalate as the support.

Thus, for instance, as a second functional layer for a support it is possible to use high-transparency films which at the same time have a refractive index nd of 1.52, a haze value of less than 3% according to ASTM D1003 (or, even more advantageously, less than 2%) and a transmittance of more than 86% for light with a wavelength of 550 nm in accordance with ASTM D1003.

Described below are, first of all, a number of base materials for supports which represent the second functional layer. Suitability for this purpose is possessed by high-transparency films, such as those of polyethylene terephthalate (PET), for example. Thus, for example, a number of the films sold under the name Hostaphan™ by Mitsubishi or under the name Lumirror™ by Toray have emerged as being favourable, with the high-transparency forms Lumirror™ 60 being suitable more particularly for use according to the invention (refractive indices nd of around 1.48). An example of a further suitable polyester is polybutylene terephthalate.

Besides polyester films it is also possible to use other high-transparency films, such as those based on polyvinyl chloride (PVC), polycarbonate (PC; refractive index nd of around 1.60), polyvinyl alcohol, polyvinylbutyral, polyamide, including copolyamide, polyimide, polyurethane (PU), polymethyl methacrylate (PMMA; refractive index nd of around 1.49) or polystyrene (PS), and also materials derived from these. In accordance with the invention it is also possible, for example, besides pure polystyrene films, to use film materials which as well as styrene contain other comonomers, butadiene for instance, in order to reduce the crystallization tendency of the film and so to increase the transmittance.

Further suitable materials are those from the groups of the polyethersulphones and polysulphones; they are sold, for example, by BASF under the names Ultrason™ E and Ultrason™ S.

In addition it is also possible for high-transparency thermoplastic elastomers based on urethane (TPU) to be employed, of the kind available commercially from Elastogran GmbH, for instance.

The base materials for supports which represent the first functional layer are likewise specified according to their refractive index. Suitable supports, therefore, are high-transparency polyolefins, such as polypropylene (PP), it being particularly advantageous for films of this kind not to have crystalline regions which can reduce the transparency. For this purpose, for instance, the support may be unoriented (in the form of cast polypropylene) or of oriented material, such as mono-oriented (MOPP) or biaxially oriented (BOPP). Another polyolefin with support suitability is, for example, functionalized polyethylene (PE). Thus, as well as ethylene, it is also possible to employ cyclohexene or derivatives of norbonene as comonomers which reduce crystallization, or else other olefinic comonomers which are used in addition to ethylene and reduce the occurrence of crystalline domains through their steric arrangement.

Likewise suitable as a first functional layer is triacetylcellulose (TAC) and also further cellulose derivatives, examples being cellulose butyrate, cellulose propionate and ethylcellulose, each of which may be used in the form of homopolymers or as comonomers, and also in blends.

In order to be able to tailor the properties of such films in the first or second functional layers, these films may of course also include further constituents, examples being plasticizers for increased flexibility. Furthermore, the surface of the support may be treated, by applying a thin coating, an adhesion promoter, for example, by vapour deposition.

Besides the single-layer films it is also possible to employ multi-layer films which may be produced, for instance, via coextrusion. For this purpose it is possible to combine the aforementioned polymer materials with one another.

In order first to offer sufficient mechanical stability, for splinter protection, and secondly to ensure high transmittance and ease of processing, the supports used for a 2D element of the invention are normally film materials having a thickness from a range between 4 and 150 μm, preferably from a range from 12 to 100 μm or even from a range from 23 to 75 μm.

It may be advantageous, furthermore, if the support can be punched or cut with dimensional stability and also has sufficient thermal stability to withstand processing at relatively high temperatures, such as when a hot-meltable adhesive is applied from the melt.

Disposed on the first side face of the second functional section is an adhesive coating. An adhesive coating is an adhesive which is spread out at least substantially in sheetlike format and which therefore likewise possesses a principal extent and a secondary extent. The adhesive is adapted for permanent joining of the 2D element to a brittle 2D body which must be held together by means of the 2D element in the event of fracture.

A 2D body in the present case is any body that forms a substrate for the 2D element and has at least one two-dimensional sub-region whose extent corresponds approximately to the principal extent of the 2D element, irrespective of the specific nature of this body in terms of its other dimensions. This 2D body, moreover, is brittle, thus having a high brittleness and hence also being hard, so that under the influence of an external force it is virtually unable to undergo plastic deformation and instead undergoes fracture. Typical examples of brittle 2D bodies of this kind are glasses with a silicatic basis, which may have different compositions, such as quartz glass, borate glass, laboratory glass, window glass, float glass, lead crystal glass, crown glass, soda-lime glass and the like. If fracture of the brittle 2D body occurs, the 2D element adhered unilaterally to the top face of the 2D body serves as splinter protection by holding together the fragments of the 2D body, including any splinters, by virtue of the adhesive force of the adhesive.

In accordance with the invention, moreover, the adhesive coating is adapted for a high adhesive force on the brittle 2D body, such as a force of more than 3.5 N/cm or even of more than 4.0 N/cm, for example. Such adaptation is obtained, for instance, through the tailoring of the adhesive of the adhesive coating in respect of the specific substrate, such tailoring possibly encompassing not only the selection of one or more polymers as adhesives but also, for example, controlled additization of the adhesive.

For adhesives which can be used in accordance with the invention another important factor, as well as adaptation of the adhesive force, is the refractive index of the adhesive. Hence the adhesive of the adhesive coating is to have a refractive index nd(20° C.) from a range from 1.43 to 1.60, preferably from a range from 1.47 to 1.58, more preferably from a range from 1.47 to 1.50.

By this means it is possible to obtain a particularly transparent system. Measures for such adaptation may constitute all suitable specific measures, such as the choice of a polymer system having a suitable refractive index as adhesive, or the addition of a suitable additive to the adhesive. Examples of suitable polymer systems are found below.

In principle, accordingly, it is possible to use any desired adhesives, provided that they have the properties needed to obtain the inventive effect, in terms, for instance, of their absorption behaviour and refractive index and also in terms of the adhesive force on the respective substrate. Thus, for example, both pressure-sensitive adhesives and heat-activable adhesives are suitable in principle, although the former are to be preferred for reasons of the higher transparency. Described below, purely by way of example, are a number of typical adhesive systems which have emerged as being particularly advantageous in connection with the present invention.

On the basis of practical considerations, the use of pressure-sensitive adhesives (PSAs) is of advantage more particularly. Suitable pressure-sensitive adhesives based on silicone systems are described in U.S. Pat. No. 4,874,671, for example, and can be used to produce adhesives with refractive indices of more than 1.47.

With preference, however, acrylate-based PSAs are also employed. Adhesives of this kind are composed of acrylic (acrylate-like) monomers. The group of acrylic monomers is composed of all compounds having a structure which can be derived from the structure of unsubstituted or substituted acrylic acid or methacrylic acid or else from esters of these compounds (these options are designated collectively by the term “(meth)acrylates”). These monomers can be described by the general formula CH2=C(R′)(COOR″) where the radical R′ may be a hydrogen atom or a methyl group and the radical R″ may be a hydrogen atom or else is chosen from the group of the saturated, unbranched or branched, substituted or unsubstituted C1- to C30-alkyl groups. In order to avoid optical detractions from the adhesive as a result of admixtures in the monomers, the monomers are preferably purified prior to use in order to remove, for instance, any ageing inhibitors, which discolour under the influence of light.

The (meth)acrylate-based polymers of these PSAs are obtainable for instance by free-radical addition polymerization, the polymer frequently having an acrylic monomer content of 50% by weight or more.

These monomers are typically chosen such that the resulting polymer compositions can be used, at room temperature or higher temperatures, as PSAs, possessing pressure-sensitive adhesion properties in accordance with the “Handbook of Pressure Sensitive Adhesive Technology” by Donatas Satas (van Nostrand, New York 1989).

In the context of the optical properties of the product it is of advantage for the (meth)acrylate PSAs to have refractive indices nd of more than >1.47 (at 20° C.).

(Meth)acrylate PSAs can be obtained preferably by polymerization of a monomer mixture which comprises acrylic esters and/or methacrylic esters and/or the free acids thereof with the formula CH2=C(R′)(COOR′″) where R′ is H or CH3 and R′″ is H or an alkyl chain having 1-20 C atoms. The poly(meth)acrylates in this case typically have molecular weights (molar masses) Mw of more than 200 000 g/mol.

Monomers which can be used include, for instance, acrylic monomers or methacrylic monomers which comprise acrylic and methacrylic esters having alkyl groups of 4 to 14 C atoms, typically of 4 to 9 C atoms. Specific examples, without wishing to be restricted by this enumeration, are methyl acrylate, methyl methacrylate, ethyl acrylate, n-butyl acrylate, n-butyl methacrylate, n-pentyl acrylate, n-hexyl acrylate, n-heptyl acrylate, n-octyl acrylate, n-octyl methacrylate, n-nonyl acrylate, lauryl acrylate, stearyl acrylate, behenyl acrylate or the branched isomers thereof such as isobutyl acrylate, 2-ethylhexyl acrylate, 2-ethylhexyl methacrylate, isooctyl acrylate or isooctyl methacrylate, for instance.

Further monomers which can be used are monofunctional acrylates and methacrylates of bridged cycloalkyl alcohols composed of at least 6 C atoms. The cycloalkyl alcohols can also be substituted, for example by C1- to C6-alkyl groups, halogen atoms or cyano groups. Specific examples are cyclohexyl methacrylate, isobornyl acrylate, isobornyl methacrylate and 3,5-dimethyladamantyl acrylate.

It is possible in addition to use monomers which contain polar groups such as carboxyl radicals, sulphonic acid, phosphonic acid, hydroxyl, lactam, lactone, N-substituted amide, N-substituted amine, carbamate, epoxy, thiol, alkoxy or cyano residues and also ether groups or the like.

Examples of suitable moderate basic monomers are singly or doubly N-alkyl-substituted amides, more particularly acrylamides. Specific examples are N,N-dimethylacrylamide, N,N-dimethylmethacrylamide, N-tert-butylacrylamide, N-vinylpyrrolidone, N-vinyllactam, dimethylaminoethyl acrylate, dimethylaminoethyl methacrylate, diethylaminoethyl acrylate, diethylaminoethyl methacrylate, N-methylolacrylamide, N-methylolmethacrylamide, N-(butoxymethyl)methacrylamide, N-(ethoxymethyl)acrylamide, N-isopropylacrylamide, this enumeration not being conclusive.

Further examples of monomers are selected on account of their functional groups that can be utilized for crosslinking, such as hydroxyethyl acrylate, hydroxyethyl methacrylate, hydroxypropyl acrylate, hydroxypropyl methacrylate, allyl alcohol, maleic anhydride, itaconic anhydride, itaconic acid, glyceridyl methacrylate, phenoxyethyl acrylate, phenoxyethyl methacrylate, 2-butoxyethyl acrylate, 2-butoxyethyl methacrylate, cyanoethyl acrylate, cyanoethyl methacrylate, glyceryl methacrylate, 6-hydroxyhexyl methacrylate, vinylacetic acid, tetrahydrofurfuryl acrylate, β-acryloyloxypropionic acid, trichloroacrylic acid, fumaric acid, crotonic acid, aconitic acid, dimethylacrylic acid, this enumeration not being conclusive.

Further suitable monomers are vinyl compounds, more particularly vinyl esters, vinyl ethers, vinyl halides, vinylidene halides, vinyl compounds with aromatic rings and heterocycles in α position. Here again mention may be made, non-exclusively, of certain examples, such as vinyl acetate, vinylformamide, vinylpyridine, ethyl vinyl ether, vinyl chloride, vinylidene chloride and acrylonitrile.

With regard to the optical properties of the adhesive it is especially advantageous to use copolymers which contain comonomers which have at least one aromatic sub-region and so are able to raise the refractive index of the adhesive. Suitable such components include aromatic vinyl compounds such as styrene, for instance, the aromatic sub-regions being able preferably to have an aromatic nucleus of C4 to C18 units and optionally also to contain heteroatoms. Examples thereof are 4-vinylpyridine, N-vinylphthalimide, methylstyrene, 3,4-dimethoxystyrene, 4-vinylbenzoic acid, benzyl acrylate, benzyl methacrylate, phenyl acrylate, phenyl methacrylate, tert-butylphenyl acrylate, tert-butylphenyl methacrylate, 4-biphenylyl acrylate, 4-biphenylyl methacrylate, 2-naphthyl acrylate, 2-naphthyl methacrylate and also mixtures of these monomers, this enumeration not being exhaustive.

In the case of PSAs, however, the fraction of aromatic-substituted monomers in the adhesive is limited by the fact that the use of such monomers raises the glass transition temperature of the polymer, which results in a decrease in the tack of this polymer. Since this is an effect which is unwanted for PSAs, the aromatics fraction cannot be chosen freely arbitrarily, on account of these interactions, in dependence on the system chosen.

Through the selection of the comonomers and the fraction of these comonomers in the adhesive, therefore, it is possible to tailor the refractive index of the adhesive. Thus, when increasing the fraction of comonomers substituted by aromatic systems, the refractive index of the adhesive overall can be increased and thus the scattering of light at the boundary face between the PSA and a glass substrate can be reduced.

The comonomer composition can also be chosen such that the PSAs can be employed as heat-activable PSAs which become tacky only under temperature exposure and optional pressure and which develop a high adhesive force to the substrate after bonding and cooling have taken place, as a result of solidification. Systems of this kind have glass transition temperatures Tg of 25° C. or more.

Further examples of monomers may be photoinitiators having a copolymerizable double bond, more particularly those selected from the group containing Norrish-I or Norrish-II photoinitiators, benzoin acrylates or acrylated benzophenones (in commerce under the name Ebecryl P 36® from UCB). In principle it is possible in this context to use all of the photoinitiators known to the skilled person which on irradiation with UV light bring about crosslinking in the polymer via a free-radical mechanism. A general overview of photoinitiators which can be used, and which in that case can be functionalized with at least one double bond, is offered by Fouassier in “Photoinitiation, Photopolymerization and Photocuring: Fundamentals and Applications” (Hanser-Verlag, Munich 1995) and also, supplementarily, by Carroy et al. in “Chemistry and Technology of UV and EB Formulation for Coatings, Inks and Paints” (Oldring (Ed.), 1994, SITA, London).

More particularly it is also possible to use PSAs which comprise acrylate block copolymers. By this means it is possible, for the synthesis of a PSA of high refractive index, to be able to use a large number of different monomers, so that the PSA properties can be controlled and tailored to a wide extent through the concrete selection of monomers, as a consequence of the specific chemical compilation. Moreover it is possible in this way to obtain highly cohesive PSA layers without the need for additional crosslinking steps.

The acrylate block copolymer in this context is an acrylate block copolymer having at least one structural unit which is described by the general stoichiometric formula P(A)-P(B)-P(A). A and B here stand for one monomer or else two or more monomers of type A and, respectively, for one monomer or two or more monomers of type B which can be utilized in preparing the respective polymer block. For the purposes of this specification the term “polymer block” is therefore intended to include both homopolymer blocks and copolymer blocks unless specified otherwise in any particular case. P(A) stands for a polymer block which is obtained by polymerizing at least one monomer of type A. P(B) stands for a polymer block which is obtained by polymerizing at least one monomer of type B. Accordingly the acrylate block copolymer comprises at least the unit P(A)-P(B)-P(A) formed from at least one polymer block P(B) and at least two polymer blocks P(A), where
the polymer blocks P(A) are mutually independent homopolymer blocks or copolymer blocks each containing at least 75% by weight of monomers of type A, each of the (co)polymer blocks P(A) being polymer blocks having softening temperatures in a range from 0° C. to +175° C.,
the polymer block P(B) is a homopolymer block or copolymer block which contains monomers of type B, the (co)polymer block P(B) comprising a polymer block having a softening temperature in a range from 10° C. to 130° C.,
the polymer blocks P(A) and P(B) are not fully (homogeneously) miscible at 25° C. under application conditions,
the PSA overall has a refractive index nd of more than 1.52 at 20° C.,
at least one of the (co)polymer blocks P(A) has a refractive index nd of more than 1.58 at 20° C., and
the (co)polymer block P(B) has a refractive index nd of more than 1.43 at 20° C.

By softening temperature is meant in the present case a glass transition temperature for amorphous systems and a melting temperature in the case of semi-crystalline polymers. The temperatures reported here correspond to those obtained from quasi-steady state experiments such as, for example, with the aid of differential scanning calorimetry (DSC).

In the case of a block copolymer-based adhesive of this kind it is possible advantageously for all of the (co)polymer blocks P(A) to have a refractive index nd of more than 1.58 at 20° C. Moreover, the at least one block copolymer may also be present in the PSA in a mass fraction of 50% by weight or more.

The polymer blocks P(B) of the above general block copolymer are referred to below as elastomer blocks, whereas the polymer blocks P(A), accordingly, correspond to hard blocks.

Among the block copolymer-based PSAs, PSAs which have emerged as being exceptionally favourable are, more particularly, those which have a refractive index nd of more than 1.52 and in which the construction of the block copolymer or block copolymers can be described by one or more of the following general formulae:

P(A)-P(B)-P(A) (PI)

P(B)-P(A)-P(B)-P(A)-P(B) (PII)

[P(A)-P(B)]nX (PIII)

[P(A)-P(B)]nX[P(A)] m (PIV).

In these formulae, n and m represent positive integers, with 3≦n≦12 and 3≦m≦12. X identifies a chemical structural element which serves as a polyfunctional branching unit via which different branches of the polymer are linked to one another. Furthermore, the polymer blocks P(A) are mutually independent homopolymer blocks or copolymer blocks each containing at least 75% by weight of monomers of type A, the (co)polymer blocks P(A) each being polymer blocks having softening temperatures in a range from 0° C. to +175° C. and having a refractive index nd of more than 1.58 at 20° C. Correspondingly the polymer block P(B) or polymer blocks P(B) are homopolymer blocks or copolymer blocks containing monomers of type B, (co)polymer blocks P(B) being polymer blocks having softening temperatures in a range from 10° C. to 130° C. and a refractive index nd of more than 1.43 at 20° C.

The polymer blocks P(A) can comprise polymer chains of a single monomer variety of type A, or copolymers of monomers of different structures of type A, or, where appropriate, copolymers which comprise at least 75% by weight of monomers of type A and not more than 25% by weight of monomers of type B. The monomers of type A that are used may vary more particularly in their chemical structure and/or in the length of the side chains. The polymer blocks therefore span the range between completely homogeneous polymers, via polymers composed of monomers of identical chemical parent structure but different chain length, and those with the same number of carbon atoms but different isomerism, through to randomly polymerized blocks of monomers of different lengths with different isomerism, of type A. Similar comments apply to the polymer blocks P(B) in respect of the monomers of type B.

The unit P(A)-P(B)-P(A) may be either symmetrical—corresponding for instance to P1(A)-P(B)-P2(A) with P1(A)=P2(A)—or asymmetrical in construction, corresponding for instance to the formula P3(A)-P(B)-P4(A) with P3(A)≠P4(A), but with both P3(A) an P4(A) each being polymer blocks as defined for P(A). P3(A) and P4(A) may differ more particularly in their chemical composition and/or their chain length.

The block copolymers may have a symmetrical construction, so that there are polymer blocks P(A) identical in chain length and/or chemical structure and/or there are polymer blocks P(B) identical in chain length and/or chemical structure.

Starting monomers of type A for the polymer blocks P(A) may be selected, for example, such that the resultant polymer blocks P(A) are not miscible with the polymer blocks P(B) and, accordingly, there is microphase separation. The concept of “microphase separation” relates in this context to the formation of separate microphases, with the consequence that the different polymer blocks may be present, for example, in different elongated, microphase-separated regions (domains)—in the form, for instance, of prolate, i.e. uniaxially elongated (e.g. rodlet-shaped), oblate, i.e. biaxially elongated (e.g. layer-shaped) structural elements - or may form three-dimensionally co-continuous microphase-separated regions or a continuous matrix of one kind of polymer blocks with regions of another kind of polymer blocks dispersed therein. The domain sizes in the systems used in accordance with the invention are typically smaller than 400 nm or preferably smaller than 200 nm.

Suitable monomers of type A contain a C-C double bond, more particularly one or more vinyl groups in the true sense and/or vinylogous groups. Vinylogous groups here are those groups for which the hydrogen atoms on the unsaturated C atoms are partly or fully substituted by organic and/or inorganic radicals. In this sense, acrylic acid, methacrylic acid and/or their derivatives are included among the compounds containing vinylogous groups. Above compounds are referred to below collectively as vinyl compounds.

Advantageous examples of compounds used as monomers of type A are vinylaromatics which as polymers possess a refractive index of more than 1.58 (at 25° C.). Specific monomers, listed here merely by way of example and hence not comprehensively, include styrene, α-methylstyrene, o-methylstyrene, o-methoxystyrene, p-methoxystyrene or 4-methoxy-2-methylstyrene.

As monomers of type A it is additionally possible with advantage to use acrylates—such as, for example, acrylate-terminated polystyrene or α-bromophenyl acrylate—and/or methacrylates such as, for example, methacrylate-terminated polystyrene, available for instance as Methacromer PS 12 from Polymer Chemistry Innovations, 1,2-diphenylethyl methacrylate, diphenylmethyl methacrylate, o-chlorobenzyl methacrylate, p-bromophenyl methacrylate and/or acrylamides, an example being N-benzylmethacrylamide.

It is also possible to use two or more monomers mixed with one another. Since in principle monomer mixtures as well can be used to achieve a refractive index nd of more than 1.58 for the polymer blocks P(A), it is also possible for one or more components to possess, in homopolymer form, a refractive index nd of less than 1.58 (at 25° C.). Specific examples of comonomers of this kind (with no claim to completeness) are o-cresyl methacrylate, phenyl methacrylate, benzyl methacrylate or o-methoxyphenyl methacrylate.

Furthermore, however, the polymer blocks P(A) may also be constructed as copolymers in such a way that they consist to an extent of at least 75% by weight of the above monomers of type A or else of a mixture of these monomers, leading to a high softening temperature, and may also, to an extent of not more than 25% by weight, contain monomers of type B, leading to a lowering of the softening temperature of the polymer block P(A). Examples of alkyl acrylates that may be mentioned in this sense are those defined below corresponding to the structure B1 and the text that follows.

Monomers of type B for the polymer block P(B) are advantageously likewise chosen such that they have C—C double bonds (particularly vinyl groups and vinylogous groups), care being taken advantageously to ensure here that the polymer block P(B) has a refractive index nd of at least 1.43.

Acrylate monomers are used advantageously as monomers of type B. For this purpose it is possible in principle to use all of the acrylate compounds that are familiar to the skilled person and are suitable for the synthesis of polymers. Monomers chosen are preferably those which bring about glass transition temperatures of the polymer block P(B), alone or in combination with one or more further monomers, of less than +10° C. Accordingly it is also possible with preference to choose vinyl monomers.

For the preparation of the polymer blocks P(B) use is made advantageously of 75% to 100% by weight of acrylic acid and/or methacrylic acid derivatives of the general structure

CH2=C(R°)(COOR°°) (B1)

where R°═H or CH3 and R°°═H or linear, branched or cyclic, saturated or unsaturated hydrocarbon chains having 1 to 30 carbon atoms, more particularly having 4 to 18 carbon atoms, and also not more than 25% by weight of monomers B2 from the group of the vinyl compounds, these monomers favourably containing further functional groups.

The above weight percentages add up preferably to 100%, though the sum may also be less than 100% by weight if other (polymerizable) monomers are present.

Acrylic monomers of type B which are used very preferably in the sense of the compound B1 as components for the polymer blocks P(B) encompass acrylic esters and methacrylic esters with alkyl, alkenyl and/or alkynyl groups, consisting in each case of 4 to 18 C atoms. Specific examples of such compounds—without wishing to be restricted by this enumeration—are n-butyl acrylate, n-pentyl acrylate, n-hexyl acrylate, n-heptyl acrylate, n-octyl acrylate, n-nonyl acrylate, lauryl acrylate, stearyl acrylate, stearyl methacrylate, their branched isomers such as 2-ethylhexyl acrylate and isooctyl acrylate, and also cyclic monomers such as cyclohexyl or norbornyl acrylate and isobornyl acrylate, for example.

Additionally it is possible optionally as monomers B2 for polymer blocks P(B) to use vinyl monomers from the following groups: vinyl esters, vinyl ethers, vinyl halides, vinylidene halides and vinyl compounds which contain aromatic rings and heterocycles in a position. Here as well, selected monomers that may be used in accordance with the invention may be designated by way of example: vinyl acetate, vinylformamide, vinylpyridine, ethyl vinyl ether, 2-ethylhexyl vinyl ether, butyl vinyl ether, vinyl chloride, vinylidene chloride and acrylonitrile.

Particularly preferred examples of monomers containing vinyl groups as monomer B2 for the elastomer block P(B) further suitably include hydroxyethyl acrylate, hydroxypropyl acrylate, hydroxyethyl methacrylate, hydroxypropyl methacrylate, N-methylolacrylamide, acrylic acid, methacrylic acid, allyl alcohol, maleic anhydride, itaconic anhydride, itaconic acid, benzoin acrylate, acrylated benzophenone, acrylamide and glycidyl methacrylate, to name but a few.

All of these useful monomers may likewise be used in a halogenated form.

With particular preference, PSAs used in accordance with the invention with a refractive index of more than 1.52 contain one or more polymer blocks having one or more grafted-on side chains. The compounds in question may be compounds in which the side chains are obtained by means of a “graft-from” process (polymerizational attachment of a side chain, starting from an existing polymer backbone) or by means of a “graft-to” process (attachment of polymer chains to a polymer backbone via polymer-analogous reactions).

For preparing block copolymers with side chains it is possible more particularly, as macromonomers of types A and B, to choose monomers functionalized in such a way as to allow a “graft-from” process for the grafting-on of side chains. Particular mention may be made here of acrylate and methacrylate monomers which carry halogen functionalization or functionalization through other functional groups which permit, for example, an ATRP (atom transfer radical polymerization) process. In this context mention may also be made of the possibility of introducing side chains into the polymer chains in a targeted way via the addition of macromonomers during the polymerization.

In one specific embodiment of this invention there are one or more functional groups incorporated in the polymer blocks P(B) that permit radiation-chemical crosslinking of the polymer blocks, more particularly by means of irradiation with ultra-violet light (UV light) or bombardment with rapid electrons (electron beam curing). As monomer units of type B it is possible, with this objective, to make use more particularly of acrylic esters which contain an unsaturated hydrocarbon radical having 3 to 18 carbon atoms and containing at least one carbon-carbon double bond. Suitable acrylates of this kind with double bond modification include, in particular, allyl acrylate and acrylated cinnamic esters. Besides acrylic monomers, other monomers which can be used for the polymer block P(B) are, advantageously, vinyl compounds with double bonds that do not react during the (free-radical) polymerization of the polymer block P(B). Particularly preferred examples of such comonomers are isoprene and/or butadiene, but also chloroprene.

In a further embodiment of the PSA, polymer blocks P(A) and/or P(B) are functionalized such that it is possible to implement a thermally initiated crosslinking. Crosslinkers which may be chosen include the following: epoxides, aziridines, isocyanates, polycarbodiimides and metal chelates, to name but a few.

One preferred characteristic of the PSAs is that the number-averaged average molecular weight Mn of at least one of the block copolymers, more particularly all of the block copolymers when there are two or more block copolymers, is between 10 000 and 600 000 g/mol, preferably between 30 000 and 400 000 g/mol and more preferably between 50 000 g/mol and 300 000 g/mol.

The fraction of the polymer blocks P(A) is situated advantageously within a range from 5% to 40% by weight of the overall block copolymer, preferably between 7.5% and 35% by weight and more preferably between 10% and 30% by weight. The polydispersity D of the block copolymer is preferably less than 3, as given by the ratio of mass average Mw to number average Mn of the molecular weight distribution. Where there are two or more block copolymers in the PSA of the invention, the above figures for the fractions and the polydispersity D apply advantageously to at least one of the block copolymers, but preferably to all of the block copolymers present.

Furthermore, the ratio VA/B [VA/B= l̅P(A)/ l̅P(B)] of the average chain lengths l̅P(A) of the polymer blocks P(A) to the chain lengths l̅P(B) of the polymer blocks P(B) can be chosen such that the polymer blocks P(A) are present in the form of a disperse phase (“domains”) in a continuous matrix of the polymer blocks P(B), more particularly in the form of spherical or distortedly spherical or cylindrical domains. This may be the case more particularly where the polymer block P(A) content is less than about 25% by weight. The formation of hexagonally packed cylindrical domains of the polymer blocks P(A) is likewise possible.

In the case of further PSAs which can be used in accordance with the invention the PSA comprises a mixture (blend) of
at least one diblock copolymer with at least one triblock copolymer, or
at least one diblock copolymer with at least one star-shaped block copolymer, or
at least one triblock copolymer with at least one star-shaped block copolymer,
   with preferably at least one of the aforementioned components, advantageously all of the block copolymer components, of the blend representing block copolymers as defined in the main claim.

Thus, for instance, the mixtures below have emerged as being favourable such blends, the said mixtures comprising blends of block copolymers above containing the sequence P(A)-P(B)-P(A) with diblock copolymers P(A)-P(B), the corresponding polymer blocks P(A) and P(B) being preparable using the same monomers as described above. It is also possible to add polymers P′(A) and/or P′(B) to a PSA which comprises block copolymers such as, more particularly, triblock copolymer PI or a block copolymer/diblock copolymer blend, for the purpose of improving its properties.

Accordingly it is also possible in accordance with the invention to use PSAs based on a blend of at least one block copolymer which at 20° C. has a refractive index nd of more than 1.52 and a diblock copolymer P(A)-P(B),
where the polymer blocks P(A) of the diblock copolymers independently of one another represent homopolymer or copolymer blocks of the monomers of type A and in each case have a softening temperature in a range from 0° C. to +175° C. and also a refractive index nd of more than 1.58, and
where the polymer blocks P(B) of the diblock copolymers independently of one another represent homopolymer or copolymer blocks of the monomers of type B and in each case have a softening temperature in a range from 130° C. to +10° C. and also a refractive index nd of more than 1.43,
   and/or with polymers P′(A) and/or P′(B),
where the polymers P′(A) represent homopolymers and/or copolymers of monomers of type A and in each case have a softening temperature in a range from 0° C. to +175° C. and also a refractive index nd of more than 1.58,
where the polymers P′(B) represent homopolymers and/or copolymers of monomers of type B and in each case have a softening temperature in a range from 130° C. to +10° C. and also a refractive index nd of more than 1.43, and
where the polymers P′(A) and P′(B) are preferably miscible with the polymer blocks P(A) and P(B), respectively, in the above block copolymers.

Where both polymers P′(A) and polymers P′(B) are admixed, they are advantageously chosen such that the polymers P′(A) and P′(B) are not homogeneously miscible with one another.

Monomers used for the diblock copolymers P(A)-P(B), for the polymers P′(A) and P′(B) respectively, are preferably the above-stated monomers of types A and B.

The diblock copolymers here typically have a number-averaged average molecular weight Mn of between 5000 and 600 000 g/mol, preferably between 15 000 and 400 000 g/mol and more preferably between 30 000 and 300 000 g/mol. They advantageously possess a polydispersity D, i.e. Mw/Mn, which is not greater than 3. It is advantageous if the fraction of the polymer blocks P(A) in relation to the composition of the diblock copolymer is between 3% and 50% by weight or even between 5% and 35% by weight.

Typical proportions of diblock copolymers in the blend are not more than 250parts by weight to 100parts by weight of block copolymer containing the unit P(A)-P(B)-P(A). The polymers P′(A) and P′(B) respectively may in this case be constructed as homopolymers and also as copolymers. They are frequently chosen, in accordance with the observations above, in such a way as to be compatible with the polymer blocks P(A) and P(B), respectively, in the block copolymer above. The chain length of the polymers P′(A) and P′(B) is preferably chosen such that it does not exceed the chain lengths of the respective polymer block with which they are miscible and/or associable and advantageously is less by about 10% or even by 20% than the said chain lengths. The B block can also be chosen such that its length does not exceed half of the length of the B block of the triblock copolymer.

Overall it is possible to vary the compositions for the adhesives within a wide range by changing the nature and proportion of the reactants. It is also possible to exert control over further product properties such as colour, thermal conductivity or electrical conductivity, for example, through addition of auxiliaries. For this purpose, an adhesive may comprise further formulating ingredients and/or auxiliaries such as, for example, plasticizers, fillers (such as fibres, zinc oxide particles, solid or hollow glass beads, microbeads made from other materials, silica, silicates, for example), electrically conductive materials (such as undoped or doped conjugated polymers or metal salts) and/or ageing inhibitors (such as primary or secondary antioxidants) or light stabilizers. It is important here, however, that these further ingredients do not, or not substantially, reduce the transmission of the PSA for light from a particular wavelength range. As well as the nature of the auxiliary, this is also dependent on the concentration of the auxiliary in the adhesive and also on the specific form in which the auxiliary is used—for example, the average particle size. The formulation of the adhesive with further ingredients of this kind such as fillers and plasticizers, for example, is likewise state of the art.

In order to adapt the specific technical properties of the adhesive to the particular application it is possible to add bond strength-enhancing or tackifying resins to the PSAs. Resins which can be used as resins of this kind—referred to as tackifier resins—include, without exception, all tackifier resins that are known and are described in the literature and that do not reduce the transparency of the adhesive. Typical tackifier resins include pinene resins, indene resins and rosins, their disproportionated, hydrogenated, polymerized and esterified derivatives and salts, the aliphatic and aromatic hydrocarbon resins, terpene resins and terpene-phenolic resins, and also C5, C9 and other hydrocarbon resins. These and further resins may be used individually or in any desired combinations in order to adjust the properties of the resultant adhesive in accordance with the application. Generally speaking it is possible to use all resins that are compatible with (soluble in) the corresponding thermoplastic material, more particularly aliphatic, aromatic or alkylaromatic hydrocarbon resins, hydrocarbon resins based on pure monomers, hydrogenated hydrocarbon resins, functional hydrocarbon resins and natural resins. Express reference may be made to the depiction of the state of the art in the “Handbook of Pressure Sensitive Adhesive Technology” by Donatas Satas (van Nostrand, 1989).

Particular attention should be paid in this context to using exclusively resins which are substantially transparent and are very highly compatible with the polymer. These requirements are met by—among others—certain hydrogenated or partly hydrogenated resins. When selecting the resins it is of course likewise necessary to take account of any possible effect on the refractive index. Thus, for example, certain resins with a high hydrogenated and aliphatic component may lower the refractive index, while other resins, with a high aromatic fraction, may raise the refractive index.

For the polymerization the monomers are selected such that the resultant bondable polymers can be used, at room temperature or higher temperatures, as heat-activable adhesives or as pressure-sensitive adhesives, more particularly such that the resulting base polymers exhibit adhesive or pressure-sensitive adhesive properties in the sense of the “Handbook of Pressure Sensitive Adhesive Technology” by Donatas Satas (van Nostrand, N.Y. 1989). Targeted control of the glass transition temperature may be exerted to this end for instance via the compilation of the monomer mixture on which the polymerization is based.

To obtain a polymer glass transition temperature Tg of ≧25° C. for heat-activable adhesives the monomers are, for instance, selected, and the quantitative composition of the monomer mixture chosen, in such a way as to give the desired value of the glass transition temperature Tg for the polymer in accordance with equation (E1) in analogy to the equation presented by Fox (cf. T. G. Fox, Bull. Am. Phys. Soc. 1 (1956) 123):

$$\frac{1}{{T}_{g}} = {\sum }_{n} \frac{{w}_{n}}{{T}_{g , n}} . \qquad ( E 1 )$$

In this equation, n is the serial number of the monomers used, wn is the mass fraction of the respective monomer n (in % by weight) and Tg,n is the respective glass transition temperature of the homopolymer of the respective monomer n (in K).

The poly(meth)acrylate PSAs can be prepared in the typical synthesis methods for such polymers, as for example in conventional free-radical polymerizations or in controlled free-radical polymerizations. For the polymerizations which proceed by a free-radical mechanism, initiator systems are used which contain further free-radical initiators for the polymerization, more particularly thermally decomposing free-radical-forming azo or peroxo initiators. Suitability is possessed in principle, however, by all of the initiators that are familiar to the skilled person and typical for acrylates. The generation of C-centred free radicals, for instance, is described in Houben-Weyl, Methoden der Organischen Chemie, Vol. E 19a, pp. 60-147. These methods may, among others, be employed in an analogous way.

Examples of sources of suitable free-radical initiator systems are, for example, peroxides, hydroperoxides and azo compounds, such as potassium peroxodisulphate, dibenzoyl peroxide, cumene hydroperoxide, cyclohexanone peroxide, di-tert-butylperoxide, azodiisobutyronitrile (AIBN), cyclohexylsulphonyl acetyl peroxide, diisopropyl percarbonate, tert-butyl peroctoate, benzpinacol and the like. Thus, for example, as a free-radical initiator it is possible to use 1,1′-azobis(cyclohexanecarbonitrile), which is available commercially under the name Vazo 88™ from DuPont.

The number-averaged average molecular weights Mn of the adhesives formed in the free-radical polymerization are chosen for example so as to lie within a range from 200 000 to 4 000 000 g/mol; specifically for use as hot-melt PSAs, PSAs with average molecular weights Mn of 400 000 to 1 400 000 g/mol are prepared. The average molecular weight is determined by way of size exclusion chromatography (SEC) or matrix-assisted laser desorption/ionization coupled with mass spectrometry (MALDI-MS).

The polymerization may be carried out in bulk, in the presence of one or more organic solvents, in the presence of water or in mixtures of organic solvents and water. Typically the amount of solvent used should be kept as low as possible. Suitable organic solvents are, for instance, pure alkanes (for example hexane, heptane, octane, isooctane), aromatic hydrocarbons (for example benzene, toluene, xylene), esters (for example ethyl acetate, propyl acetate, butyl acetate or hexyl acetate), halogenated hydrocarbons (for example chlorobenzene), alkanols (such as, for example, methanol, ethanol, ethylene glycol, ethylene glycol monomethyl ether) and ethers (for example diethyl ether, dibutyl ether) and also mixtures thereof. Aqueous polymerization reactions can have a water-miscible or hydrophilic cosolvent added to them in order to ensure that during the monomer conversion the reaction mixture is in the form of a homogeneous phase. Use may be made, for example, of co-solvents from the group consisting of aliphatic alcohols, glycols, ethers, glycol ethers, pyrrolidines, N-alkylpyrrolidinones, N-alkylpyrrolidones, polyethylene glycols, polypropylene glycols, amides, carboxylic acids and salts thereof, esters, organic sulphides, sulphoxides, sulphones, alcohol derivatives, hydroxy ether derivatives, amino alcohols, ketones and the like and also derivatives and mixtures of these.

The polymerization time may amount, depending on conversion and temperature, to between 2 and 72 hours. The higher the reaction temperature that can be chosen, in other words the higher the thermal stability of the reaction mixture, the shorter the reaction time can be.

For initiating the polymerization the supply of heat is essential for thermally decomposing initiators. The polymerization can be initiated, depending on the type of initiator, by heating at 50° C. to 160° C. for thermally decomposing initiators of this kind.

In order to obtain poly(meth)acrylate PSAs having a narrow molecular weight distribution, controlled free-radical polymerizations are among the reactions conducted. In that case for the polymerization it is preferred to use a control reagent having the following general formula:

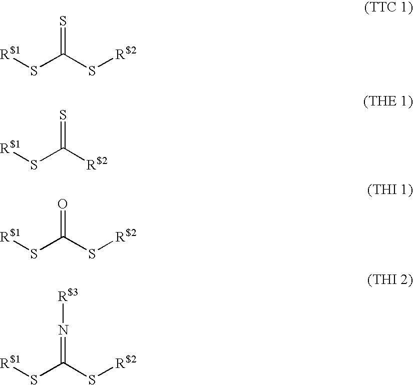

R$1 and R$2 may for this purpose be chosen identically or independently of one another and R$3 may where appropriate be chosen so as to be identical to or different from one or both groups R$1 and R$2. The radicals in this case are sensibly chosen from one of the following groups:
C1 to C18 alkyl radicals, C3 to C18 alkenyl radicals and C3 to C18 alkynyl radicals, in each case linear or branched;
C1 to C18 alkoxy radicals;
C1 to C18 alkyl radicals, C3 to C18 alkenyl radicals and C3 to C18 alkynyl radicals each substituted by at least one OH group or halogen atom or silyl ether;
C2 to C18 heteroalkyl radicals having at least one O atom and/or one NR* group in the carbon chain, R* being any desired radical, more particularly an organic radical;
C1 to C18 alkyl radicals, C3 to C18 alkenyl radicals and C3 to C18 alkynyl radicals each substituted by at least one ester group, amine group, carbonate group, cyano group, isocyano group and/or epoxide group and/or by sulphur;
C3 to C12 cycloalkyl radicals;
C6 to C18 aryl radicals and C6 to C18 benzyl radicals;
hydrogen.

Control reagents of type TTC I originate typically from classes of compound of the types listed above, which are additionally specified below:

The respective halogen atoms are chlorine and/or bromine and/or else, where appropriate, fluorine and/or iodine.

The alkyl, alkenyl and alkynyl radicals in the various substituents contain linear and/or branched chains.

Examples of alkyl radicals which contain 1 to 18 carbon atoms are methyl, ethyl, propyl, isopropyl, butyl, isobutyl, tert-butyl, pentyl, 2-pentyl, hexyl, heptyl, octyl, 2-ethylhexyl, tert-octyl, nonyl, decyl, undecyl, tridecyl, tetradecyl, hexadecyl and octadecyl.

Examples of alkenyl radicals having 3 to 18 carbon atoms are propenyl, 2-butenyl, 3-butenyl, isobutenyl, n-2,4-pentadienyl, 3-methyl-2-butenyl, n-2-octenyl, n-2-dodecenyl, isododecenyl and oleyl.

Examples of alkynyl having 3 to 18 carbon atoms are propynyl, 2-butynyl, 3-butynyl, n-2-octynyl and n-2-octadecynyl.

Examples of hydroxy-substituted alkyl radicals are hydroxypropyl, hydroxybutyl and hydroxyhexyl.

Examples of halogen-substituted alkyl radicals are dichlorobutyl, monobromobutyl and trichlorohexyl.

A typical C2 to C1 8 heteroalkyl radical having at least one O atom in the carbon chain is for example —CH2-CH2-O—CH2-CH3.

Examples of suitable C3 to C12 cycloalkyl radicals include cyclopropyl, cyclopentyl, cyclohexyl and trimethylcyclohexyl.

Examples of C6 to C18 aryl radicals include phenyl, naphthyl, benzyl, 4-tert-butylbenzyl or other substituted phenyls such as, for instance, those substituted by an ethyl group and/or by toluene, xylene, mesitylene, isopropylbenzene, dichlorobenzene or bromotoluene.

The listing above offers only examples of the respective classes of compound and is therefore not complete.

It is possible, furthermore, to carry out the polymerization of the (meth)acrylate PSAs in bulk, without addition of solvents. This can be done by standard methods, such as by means of a prepolymerization. In that case the polymerization is initiated with light from the UV range of the spectrum and the reaction is continued to a low conversion of about 10-30%. The high-viscosity prepolymer composition obtained in this way can then be processed further in the form of a polymer syrup, it being possible, for example, first to store the reaction mixture in a form in which it is welded in films—such as in ice-cube bags—before, finally, it is polymerized in water to a high ultimate conversion.

The pellets obtained in this way can be employed, for instance, as hot-melt acrylate adhesives, with melt application being carried out to film materials which are compatible with the polyacrylate product obtained.

As a further suitable preparation process, reference may be made to a variant of RAFT polymerization (reversible addition-fragmentation chain transfer polymerization). A polymerization process of this kind is described exhaustively in WO 98/01478 A1, for example. In this case polymerization is typically carried out only to low levels of conversion, in order to realize molecular weight distributions that are as narrow as possible. As a result of the low conversions, however, these polymers cannot be used as PSAs and more particularly not as hotmelt PSAs, since the high fraction of residual monomers would adversely affect the technical adhesive properties, the residual monomers contaminate the solvent recyclate in the concentration process, and the self-adhesive tapes manufactured therewith would exhibit severe outgassing behaviour. In order to circumvent the disadvantage of low conversions, the polymerization can be initiated a number of times.

As a further controlled free-radical polymerization method it is possible to carry out nitroxide-controlled polymerizations. For stabilization of free radicals in this case it is possible to use typical free-radical stabilizers, such as nitroxides of type (NIT 1) or (NIT 2):

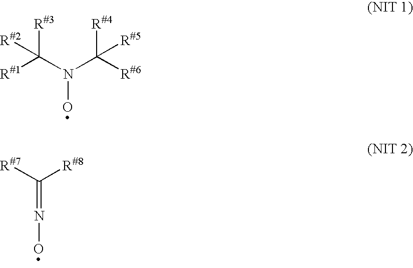

where R#1, R#2, R#3, R#4, R#5, R#6, R#7, R#8 independently of one another may represent the following atoms or groups:
i) halides such as chlorine, bromine or iodine, for example,
ii) linear, branched, cyclic and heterocyclic hydrocarbons having 1 to 20 carbon atoms, which may be saturated, unsaturated or aromatic,
iii) esters —COOR#9, alkoxides —OR#10 and/or phosphonates —PO(OR#11)2, where R#9, R#10 and/or R#11 stand for radicals from the above group ii).

Compounds of the structure (NIT 1) or (NIT 2) may also be bound to polymer chains of any kind (primarily in the sense that at least one of the abovementioned radicals constitutes one such polymer chain) and may therefore be used as macroradicals or macroregulators in the construction of block copolymers.

As controlled regulators for the polymerization it is likewise possible to use compounds of the following types:
2,2,5,5-tetramethyl-1-pyrrolidinyloxyl (PROXYL), 3-carbamoyl-PROXYL, 2,2-dimethyl-4,5-cyclohexyl- PROXYL, 3-oxo- PROXYL, 3-hydroxylimine-PROXYL, 3-aminomethyl-PROXYL, 3-methoxy-PROXYL, 3-tert-butyl- PROXYL, 3,4-di-tert-butyl-PROXYL
2,2,6,6-tetramethyl-1-piperidinyloxyl (TEMPO), 4-benzoyloxy-TEMPO, 4-methoxy-TEMPO, 4-chloro-TEMPO, 4-hydroxy-TEMPO, 4-oxo-TEMPO, 4-amino-TEMPO, 2,2,6,6-tetraethyl- 1piperidinyloxyl, 2,2,6-trimethyl-6-ethyl-1-piperidinyloxyl
N-tert-butyl 1-phenyl-2-methylpropyl nitroxide
N-tert-butyl 1-(2-naphthyl)-2-methylpropyl nitroxide
N-tert-butyl 1-diethylphosphono-2,2-dimethylpropyl nitroxide
N-tert-butyl 1-dibenzylphosphono-2,2-dimethylpropyl nitroxide
N-(1-phenyl-2-methylpropyl) 1diethylphosphono-1-methylethyl nitroxide
di-tert-butyl nitroxide
diphenyl nitroxide
tert-butyl tert-amyl nitroxide.

A series of further polymerization methods via which adhesives can be prepared in an alternative procedure may be chosen from the prior art:

Hence U.S. Pat. No. 4,581,429 A discloses a controlled-growth free-radical polymerization process which employs as its initiator a compound of the general formula R′R″N—O—Y, in which Y is a free radical species which is able to polymerize unsaturated monomers. The reactions, however, generally exhibit low levels of conversion. Particularly problematic is the polymerization of acrylates, which proceeds only to very low yields and with low molecular masses. WO 98/13392 A1 describes open-chain alkoxyamine compounds which have a symmetrical substitution pattern. EP 735 052 A1 discloses a process for preparing thermoplastic elastomers having narrow molecular weight distributions. WO 96/24620 A1 describes a polymerization process in which specific free-radical compounds are used, such as, for example, nitroxides based on imidazoline and containing phosphorus. WO 98/44008 A1 discloses specific nitroxyls which are based on morpholines, piperazinones and piperazinediones. DE 199 49 352 A1 describes heterocyclic alkoxyamines as regulators in controlled-growth free-radical polymerizations. Furthermore, corresponding further developments of the alkoxyamines and of the corresponding free nitroxides may improve the efficiency for preparing polyacrylates.

As a further controlled polymerization method it is possible to use atom transfer radical polymerization (ATRP; see above) to synthesize the copolymers, in which case, typically, monofunctional or difunctional secondary or tertiary halides and, for abstracting the halide or halides, complexes of Cu, Ni, Fe, Pd, Pt, Ru, Os, Rh, Co, Ir, Ag or Au are used as initiator (cf., for instance, EP 824 110 A1, EP 0 824 111 A1, EP 826 698 A1, EP 841 346 A1 or EP 850 957 A1). Various possibilities of ATRP are described further in U.S. Pat. No. 5,945,491 A, U.S. Pat. No. 5,854,364 A and U.S. Pat. No. 5,789,487 A.

Furthermore, a polymer can be prepared for a poly(meth)acrylate PSA in a living polymerization, such as in anionic polymerization, for example, with inert solvents typically being employed as the reaction medium, such as aliphatic and cycloaliphatic hydrocarbons or aromatic hydrocarbons.

The living polymer is generally represented here as PL(A)-Me, where Me is a metal from Group I of the periodic table (such as lithium, sodium or potassium, for example) and PL(A) is a growing polymer block of the acrylate monomers. The molecular weight of the polymer is governed in this case by the ratio of initiator concentration to monomer concentration.

Suitable polymerization initiators include n-propyllithium, n-butyllithium, sec-butyllithium, 2-naphthyllithium, cyclohexyllithium or octyllithium, this enumeration making no claim to completeness. Furthermore, initiators based on samarium complexes are known for the polymerization of acrylates (Macromolecules, 1995, 28, 7886) and can also be employed.

It is furthermore possible as well to use difunctional initiators such as, for example, 1,1,4,4-tetraphenyl-1,4-dilithiobutane or 1,1,4,4-tetraphenyl-1,4-dilithioisobutane. Likewise possible for use are coinitiators such as lithium halides, alkali metal alkoxides or alkylaluminium compounds, for example. Thus, for instance, the ligands and coinitiators may be chosen such that acrylate monomers such as n-butyl acrylate and 2-ethylhexyl acrylate, for example, can be polymerized directly and do not require generation in the polymer by transesterification with the corresponding alcohol.

The adhesives set out above and also further adhesives which, though not described exhaustively here, are nevertheless familiar adhesives to the skilled person are applied in accordance with the invention, in conventional methods, to the support film. In accordance with the particular application method, the adhesive can be coated from solution. For the blending of the base polymer with further constituents such as modifier resins or auxiliaries, for instance, it is possible here to use all of the known mixing or stirring techniques. Thus, for example, static or dynamic mixing assemblies may be employed in order to produce a homogeneous mixture. Blending of the base polymer with reactive resins may also, however, be carried out in the melt. For this purpose it is possible to employ kneading devices or twin-screw extruders. Blending takes place preferably with heating, in which case the mixing temperature ought to be significantly lower than the activation temperature for reactive processes in the mixing assembly, such as for a reaction of the epoxy resins.

For application of the adhesive from the melt, the solvent can be stripped off in a concentrating extruder under reduced pressure, for which purpose it is possible, for example, to use single-screw or twin-screw extruders, which preferably distil off the solvent in the same vacuum stage or in different vacuum stages and preferably possess a feed preheater. Advantageously the residual solvent fraction is less than 1% by weight or even less than 0.5% by weight.

It is possible, furthermore, additionally to admix crosslinkers and also crosslinking promoters. Examples of suitable crosslinkers for electron beam crosslinking and UV crosslinking are difunctional or polyfunctional acrylates, difunctional or polyfunctional isocyanates (including those in block form) or difunctional or polyfunctional epoxides. Furthermore, thermally activable crosslinkers may also have been added to the reaction mixture, such as Lewis acids, metal chelates or polyfunctional isocyanates.

For optional crosslinking of the adhesives it is possible for them to be admixed with any desired suitable initiators and/or crosslinkers. For instance, for subsequent crosslinking during irradiation with UV light, for example, it is possible for the adhesives to include UV-absorbing photoinitiators. Examples of suitable photoinitiators are benzoin ethers such as benzoin methyl ether or benzoin isopropyl ether, substituted acetophenones such as dimethoxyhydroxyacetophenone or 2,2-diethoxyacetophenone (available as Irgacure 651® from Ciba Geigy), 2,2-dimethoxy-2-phenyl-1-phenylethanone, substituted α-ketols such as 2-methoxy-2-hydroxypropiophenone, aromatic sulphonyl chlorides such as 2-naphthylsulphonyl chloride, and photoactive oximes such as 1phenyl-1,2-propanedione-2-(O-ethoxycarbonyl)oxime.

The photoinitiators which can be used and other initiators of the Norrish I or Norrish II type may be substituted and in this case may have any desired suitable radicals, examples being benzophenone, acetophenone, benzil, benzoin, hydroxyalkylphenone, phenyl cyclohexyl ketone, anthraquinone, trimethylbenzoylphosphine oxide, methylthiophenyl morpholine ketone, amino ketone, azobenzoin, thioxanthone, hexarylbisimidazole, triazine or fluorenone radicals, it being possible of course for these radicals to be substituted in turn, such as by one or more halogen atoms, alkyloxy groups, amino groups and/or hydroxyl groups. A representative overview in this respect is offered by Fouassier in “Photoinitiation, Photopolymerization and Photocuring: Fundamentals and Applications” (Hanser-Verlag, Munich 1995) and—supplementarily—by Carroy et al. in “Chemistry and Technology of UV and EB Formulation for Coatings, Inks and Paints” (Oldring (Ed.), 1994, SITA, London).

Furthermore, either the first functional layer or the second functional layer has an adapter. This is likewise of sheetlike design and has two side faces parallel to its principal extent, a first side face and a second side face.

An adapter in the present context is any means which is adapted and suitable for specifically influencing individual optical properties of the overall 2D element. Moreover, the adapter allows the chosen optical property of a first material that borders the first side face of the adapter to be matched to the corresponding optical property of a second material that borders the second side face of the adapter, as a result of which the two materials bordering the adapter are matched to one another.

Where the optical property to be matched by the adapter is absorption, for example, the adapter may be designed in the form of an intensity profile means or colour profile means. Where the optical property in question is the refractive index, the adapter may be designed, for example, as an anti-reflection means.

An anti-reflection means is any means which can be used to reduce the reflection that occurs at an interface. As observed above, the principle of an anti-reflection means of this kind may be based on adaptation of the refractive indices of the materials forming the interface. In the present case the anti-reflection means is used for the purpose of reducing the visible light that is reflected on the outside of the 2D element of the invention.

An anti-reflection means of this kind may have any desired geometric form, including both regular and irregular forms. An anti-reflection coating is a sheetlike anti-reflection means whose secondary extent—the coat thickness—is smaller by a multiple than its principal extent—the lateral dimensions—and that is constructed preferably homogeneously in chemical terms normal to the secondary extent and parallel to the principal extent.

As described above, this can be achieved, for instance, through the use of an anti-reflection means comprising a material whose refractive index lies between those of the surrounding phases. Where the adapter is used in the first functional layer, these two phases are the support of the second functional layer and the air surrounding the 2D element (or—depending on the final arrangement to be obtained in the display system—a second adhesive for the bonding of the composite system to the outside of the display device). If, in contrast, the adapter is used as a second functional layer, then the two phases are the layered adhesive system and the support of the first functional layer.

As the material for the anti-reflection means it is possible to employ all materials and combinations of materials that are suitable in terms of their refractive indices and adhesion properties. The adapter and hence also the anti-reflection means may be of single-ply or multi-ply construction.

Listed first of all in the text below are a number of examples of anti-reflection means as the first functional layer, without wishing to restrict the selection as a result of this listing. Hence as single-ply anti-reflection means it is possible, for instance, to use layers of organic or inorganic materials. An inorganic layer of this kind may comprise, for instance, magnesium fluoride (MgF2) with a refractive index nd of 1.35 for light with a wavelength of 550 nm. Likewise suitable are layers of other oxides, such as of silicon dioxide (SiO2) or silicon monoxide (SiO), and also metal oxides, examples being titanium dioxide (TiO2), hafnium oxide (HfO2), magnesium oxide (MgO), zirconium dioxide (ZrO2) or tantalum oxide (Ta2O5). Apart from these oxides it is also possible to use other materials, examples being nitrides such as silicon nitride (SiNx), for instance.

Organic layers may for example be layers of polymers with a low refractive index, such as fluorinated polymers. These may also be used in combination with the aforementioned inorganic materials, either as mixtures or as multi-ply systems. Examples of multi-ply systems include, for instance, multiple-layer systems, comprising layers of silicon dioxide and/or titanium dioxide alongside fluorinated polymers.

Also possibly serving as an anti-reflection coating are materials which have been obtained in a sol-gel process from typical starting materials such as silicones, non-metal alkoxides or metal alkoxides, for instance, and also from mixtures of these substances. Accordingly it is also possible for instance to produce anti-reflection coatings on the basis of siloxanes.

Typical layer thicknesses in the case of layers of adapters of this kind are within the range from 0.2 nm to 100 nm, preferably within the range from 10 nm to 50 nm. For individual systems, such as a siloxane-based coating from a solution, it is also possible in accordance with the invention to obtain layer thicknesses of more than 100 nm, such as of 500 nm. It should be noted that differences in colour may occur as a result of additional interference processes, depending on the layer thickness and chemical composition of the individual layers or two or more layers in a multi-ply system.

Other adapters may acquire their functionality through the generation of particular surface structures. This relates, for instance, to porous coatings or layers with stochastic or periodic surface structures as anti-reflection coatings, the distance between the structures being in each case smaller than the wavelength of visible light.

In the case of an inverse construction of the 2D element, in which the adapter is present as a second functional layer, it is likewise possible to use, as adapters, all suitable materials whose refractive index meets the specifications and which at the same time exhibit sufficient bond strength not only on the adhesive coating but also on the support of the first functional layer. When monoaxially oriented polypropylene (MOPP) is used as a support it is possible, for example, for a layer of polymethyl methacrylate (PMMA) to be used as an anti-reflection coating.

The aforementioned adapters can be applied to the support or to the layered adhesive system by suitable techniques, such as by means of a solvent coating process, by means of vacuum deposition processes such as chemical gas-phase deposition (chemical vapour deposition; CVD), for example, or a plasma ion assisted deposition (PIAD) or else—where both functional layers are film materials, such as in the case of the combination of MOPP and PMMA—by means of coextrusion.

In accordance with the invention either the first or the second functional layer may be designed as adapters. If the first functional layer is designed as an adapter, then the second functional layer is a support. In this case the result is a construction in which the adapter is disposed on the outside of the 2D element. This is particularly sensible in the case, for instance, that the adapter is of particularly mechanically robust design, having for instance a high scratch resistance, since in this way the 2D element is additionally protected against mechanical damage owing to external influence. Also possible, however, is the converse construction, in which the first functional layer is designed as the support and the second functional layer as the adapter, with the result that the adapter is not disposed on the outside of the 2D element. This inverted construction makes sense, for instance, when using support materials having a particularly low refractive index.

In this context, therefore, at least one of the two side faces of the first functional layer that are parallel to the principal extent may be designed in such a way as to be stable towards mechanical stress. This encompasses a multiplicity of different designs. Thus, on the one hand, the material of the first functional layer may be chosen so as to be mechanically stable. This may encompass not only the choice of a suitable polymer with corresponding tensile strength but also the selection of a multi-ply first functional layer in which one or more plies are of additionally structurally reinforcing design, in the form for instance of applied coating material, woven fabric or the like. Structurally reinforcing elements may likewise be present embedded into the material of the first functional layer, in the form of fibres, for instance.

Prior to adhesive bonding on a see-through element, the 2D element may preferably also comprise a temporary support. This temporary support is disposed on the side of the adhesive coating that is opposite the surface of the adhesive coating that is connected to the first side face of the second functional layer, and is joined to the adhesive coating in such a way as to be detachable without residue. In this case this temporary support serves to protect the exposed, unbonded adhesive from unintended bonding and also from dust, and at the same time is to have a highly smooth surface, so that the adhesive coating does not undergo any unilateral structuring as a result. Suitable temporary supports are all typical release systems, release films and release papers, such as those of glassine or olefinic films such as high-density polyethylene (HDPE) or low-density polyethylene (LDPE), with release films in particular being suitable for this purpose on account of their ultra-smooth surfaces. For the purpose of improving the release properties, these temporary supports may additionally feature an adhesion-lowering system, such as a siliconized release ply or a release agent. Highly smooth surfaces for temporary supports can be achieved through the use of PET films free from anti-blocking agent, in combination with silicone systems applied from solution. It will be appreciated that films possessing a refractive index nd of more than 1.43 (20° C.) can also be used as temporary supports.

For the production and processing of the bondable 2D elements, dust-free conditions are of utmost importance, since even small amounts of dust in the adhesive bond may act as centres of scattering for the transient light and so may reduce the transmittance. Preferably, therefore, manufacturing and processing take place under clean-room conditions, or even, where possible, in an ultra-clean room.

At the production stage, where possible, the adhesive coating is first applied to a release film in a first coating step. Where coating here takes place from solution, the adhesive coating after this first coating step may be freed from solvent remaining in the adhesive, such as by evaporation of the solvent in a drying tunnel. Subsequently, the material of the second functional layer is applied to the adhesive coating applied to the release film, the application of this material taking place, for instance, from the melt, from solution or in the form of a film which is then laminated via a laminating roll. The latter takes place advantageously under pressure, it also being possible to heat the system additionally or instead of the pressure. Temperature and applied pressure of the laminating roll may be varied according to the activation temperature and flow characteristics of the adhesive used. Finally the material of the first functional layer is applied correspondingly.

For reasons associated with apparatus, however, the production of the adhesive coating from solution is preferred, since in this case it is possible to choose relatively low processing temperatures, thereby making it possible to avoid the formation of crystalline or partly crystalline regions in the adhesive during application, and hence also to avoid a decrease in transparency as a result of the crystalline scattering centres. For this purpose the adhesive is dissolved in a suitable solvent and applied uniformly to the support, by means for example of a doctor blade or applicator nozzle. Application from solution offers the advantage, moreover, that in this way it is possible to generate adhesive coatings with highly smooth surfaces, allowing bonds with a high transparency.

Irrespective of the technique employed, all of the solutions and melts are filtered prior to application in order to remove dust and other solid admixtures such as polymer crystallites, for instance, and so to minimize the fraction of scattering centres in the adhesive.

Within the adhesive bond, a 2D element obtained in this way typically has a thickness from a range from 5 to 300 μm, more particularly from a range from 10 to 50 μm. The coat weight of the adhesive in this case is preferably between 10 and 150 g/m2, more preferably between 20 and 100 g/m2.

A die cut in the desired form is then cut or punched from the resulting 2D element; generally speaking, at this point in time, cutting takes place only to a useful width.

A 2D element of this kind can be used in accordance with the invention as a shatterproofing device, such as for securing displays in components of consumer electronics items. A shatterproofing device is regarded as being any device which is suitable and adapted to provide the best possible prevention of the shattering of a body to be protected when that body is subjected to an external force. This can be achieved, for instance, by largely preventing any fragments detaching completely from the body and becoming separated.

Typically it is not possible to achieve complete protection from any exposure by means of a shatterproofing device. However, a safety device of this kind generally provides at least a certain degree of protection against typical exposures, such as an unintended drop of the body from heights of up to several metres. Moreover, it may occur that, despite the use of a shatterproofing device, a small part of the shards formed in the fracture nevertheless become detached, although the greatest number of the fragments are not individualized; in other words, the fragments are at least substantially held together. Ideally, a safety device might even prevent fracture of the body, such as by structural reinforcement of the body. The greater the brittleness of the body, the more important the shatterproofing device.

For use as a shatterproofing device the 2D element of the invention is affixed over the full area of a see-through element. In the case of such fixing, it is also possible for certain sub-regions of the surface of the see-through element not to be covered by the 2D element, if, for example, these sub-regions are disposed within a casing, so that external force on these sub-regions is not able to act directly. In order to achieve proof against shattering, it is necessary merely for the externally accessible sub-region of a brittle 2D body of the see-through element to be covered over its full area by the 2D element.

A see-through element in the present context is any element which has at least one transparent sub-region through which it is possible to view a display. The transparent sub-region of the see-through element may be manufactured from any typical material or materials and in the ideal case is composed of glass. The glass sub-region, as a brittle 2D body, is adapted for joining with the 2D element. The adaptation may encompass all typical and suitable measures; at its most simple, the surface of the sub-region is at least substantially smooth, thereby allowing permanent joining to the adhesive coating of the 2D element via this sub-region. Furthermore, such adaptation may in principle also encompass further measures, such as the coating of the glass surface with an adhesion-promoting varnish. Permanent joining is considered to include any joining which is not adapted for detachment; this may be achieved, for instance, through the use of a suitable adhesive as an adhesive coating on the 2D element.

As well as the transparent sub-regions, the see-through element may additionally have non-transparent sub-regions as well. These non-transparent sub-regions may be manufactured from the same material as a transparent sub-region, or from different materials. Thus, for example, non-transparent sub-regions may take the form of a mounting section, housing or frame for the attachment on other constituents of the device, or may only serve decorative purposes, examples being coloured regions. Coloured regions of this kind may be obtained, for instance, through pigments and dyes that are embedded in the surface or applied to it; by means, for example, of a varnish coating; and/or by local metallization of the surface.

Accordingly, the shatterproofing device is designed as an adhesively bonded assembly comprising the see-through element and the 2D element. The adhesively bonded assembly may further comprise additional elements, an example being mounting-frame elements for fixing the adhesively bonded assembly to a housing component.

In accordance with the invention the adhesively bonded assembly is used as a damage protection device for a display device. A damage protection device is any device suitable and adapted to prevent the functionality of a body for protection from being restricted as a consequence of external acting forces.

A display device is any functional device which comprises a display region on which certain information is displayed, such as measurements, operational status, stored or received data or the like. Display on the display region may take any desired form, examples being mechanical, electronic or other display modes. Thus, in electronic consumer-goods devices, for example, electronic displays based on liquid crystals, cathode ray tubes or light-emitting diodes are typical, and in general are manufactured on a modular basis as display modules. The display region is usually in the form of a display surface, although other geometries are encountered as well, such as in the case of holographic displays. Besides the display region, the display device may also comprise further elements, such as frame elements or housing elements and elements for the regulation and control of the display function. The display device is to be protected, in accordance with the invention, from external mechanical exposure.

Together with the adhesively bonded assembly as damage protection device, the display device forms a display system. A display system is a functional unit serving to display information. This display system may be a subsidiary part of a device or may be designed as a self-standing device. Besides the adhesively bonded assembly and the display device, a display system of the invention may comprise further components.

Within the display system the adhesively bonded assembly is arranged such that the side of the assembly at which the 2D element is disposed faces the side of the display device which is adapted for the display of the information to be displayed, namely the display region. In this arrangement the display region may be viewed completely through the adhesively bonded assembly, in other words through the see-through element and through the 2D element.

In principle the display system may be a system in its final condition (dispatch-ready condition), hence being already fully functional, or else may represent an intermediate, still to be subjected first to concluding manufacturing steps before it attains the final condition. The concluding manufacturing steps may include, for instance, the encapsulation of the display system's interior for the purpose of preventing dust penetration.

In addition to or instead of this it is also possible for adhesive bonding with foam-backed adhesive tapes to be envisaged, by which means it is possible to attain additional mechanical decoupling of the components thus bonded, serving for further enhancement of the insensitivity to impact.

The top face of the 2D element of the adhesively bonded assembly and the top face of the side of the display device that is adapted for information display may be at a distance from one another, by means of spacers, distancing pieces or as a result of the arrangement of the adhesively bonded assembly and the display device relative to one another within the casing. In order to ensure adequate transparency of the display itself, the average distance, in other words the distance of the two surfaces to one another in the end product, averaged over the total area, ought not to be more than 510 μm, and in fact preferably a maximum of 400 μm, since otherwise the proportion of reflection losses goes up. In order to achieve adequate mechanical decoupling of the two systems, so that impact on the adhesively bonded assembly is not transmitted directly to the display device, damaging it, the average distance ought, furthermore, to be at least 40 μm, and in fact preferably 50 μm.

A possible method of producing a display system by means of the above-described 2D element ought to be carried out under dust-free conditions, as for example in a clean room or ultra-clean room. Overall, in a first step, a bubble-free adhesive bond is obtained by the 2D element, cut in accordance with the respective application, being durably joined over its full area to the brittle 2D body. For this purpose it is possible to employ any typical adhesive bonding technique, with particularly good results being obtained with lamination. For this purpose, for example, the temporary support can be removed from the 2D element, and the 2D element, with the exposed adhesive, can be laminated to the brittle 2D body. Alternatively it is also possible to place punched 2D elements as die cuts on the individual sections of the see-through elements.

It is then possible to store the adhesively bonded assembly; storage in the present context includes all steps which typically take place between two processing steps, hence including keeping in a store, or transport. Furthermore, in order to obtain optimum full-area adhesive bonding of the 2D element on the see-through element, it may also be of advantage, following lamination, to store the assembly at an elevated temperature, at 40° C. for example, in order to utilize the flow behaviour of the adhesive and to remove any air inclusions from the system.

Lastly the adhesively bonded assembly is brought into a fixed arrangement with the display device, thereby forming the display system. This can be done, for example, by fixing the adhesively bonded assembly directly on the display device, or by fixing the assembly and the display device to respective mounting elements which are disposed on the same casing part or on casing parts that are joined or are to be joined to one another.

### BRIEF DESCRIPTION OF THE DRAWINGS

Further advantages and application possibilities are evident from the exemplary embodiments, which will be described below in more detail with reference to the attached drawings. In these drawings:

FIG. 1 shows a schematic representation of a longitudinal section through an inventive 2D element according to a first embodiment,

FIG. 2 shows a schematic representation of a longitudinal section through an inventive 2D element according to a second embodiment,

FIG. 3 shows a schematic representation of a longitudinal section through an inventive 2D element according to one modification of the first embodiment,

FIG. 4 shows a schematic representation of a longitudinal section through an assembly with a 2D element in a first assembly construction,

FIG. 5 shows a schematic representation of a longitudinal section through an assembly with a 2D element in a second assembly construction, and

FIG. 6 shows a schematic representation of a longitudinal section through an assembly with a 2D element in a third assembly construction.

### DETAILED DESCRIPTION OF THE INVENTION

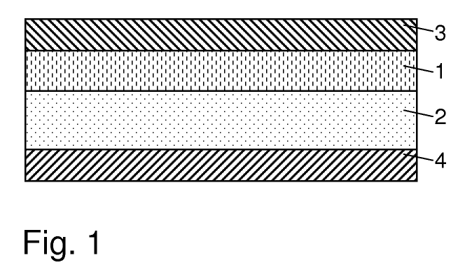

The first construction embodiment of the 2D element, shown in FIG. 1, has as its second functional layer a support 1 which is in the form of a polymer film; its adhesive coating 2 is an acrylate-based pressure-sensitive adhesive; its first functional layer is an adapter in the form of an antireflection coating 3; and its temporary support 4 is a siliconized release film. The support film 1 is covered uniformly and over its full area on one side face with the pressure-sensitive adhesive 2. Disposed on the other side face of the support 1 is the antireflection coating 3. Here, therefore, the antireflection coating 3 is disposed between the support 1 and the surrounding medium. To protect against contamination and against unwanted bonding with the release film, the adhesive 2 is covered over its full area with the temporary support 4.

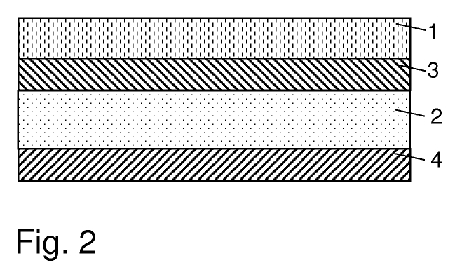

The second construction embodiment of the 2D element, shown in FIG. 2, possesses substantially the same fundamental construction as the construction embodiment shown in FIG. 1, with the difference that in this case the second functional layer is designed as antireflection coating 3 and the first functional layer as support 1. Hence in this case the antireflection coating 3 is disposed between the pressure-sensitive adhesive 2 and the support 1 (inverse construction).

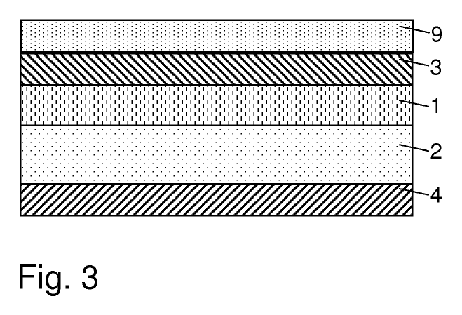

The modification of the first construction embodiment of the 2D element, shown in FIG. 3, possesses substantially the same construction as the first construction embodiment, shown in FIG. 1, with the difference that the antireflection coating 3 is additionally covered by a second adhesive 9, by means of which the 2D element, in the subsequent assembly, is fixed with the see-through element on the surface of a display device. This adhesive as well is selected such that the 2D element is overall of high transparency.

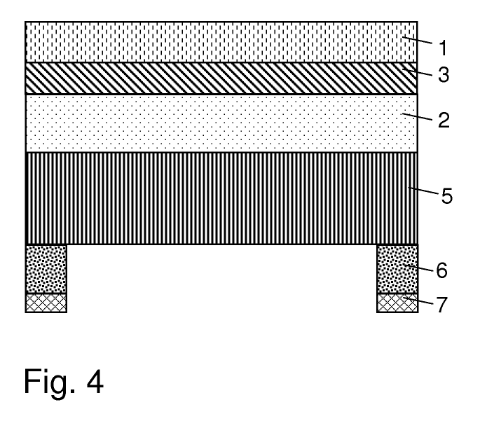

The first construction embodiment of the assembly element shown in FIG. 4, with a 2D element and a glass plate as see-through element 5, has as its 2D element a 2D element having the inverse construction shown in FIG. 2; it is equally possible to use a 2D element having a different construction, such as the construction shown in FIG. 1. In the case of the 2D element shown in FIG. 2, the release film 4 has been removed, to allow the element to be fixed flatly and without bubbles to the glass plate 5 by means of the pressure-sensitive adhesive 2. In this arrangement the support 1 forms one side face of the assembly. In order that the resulting assembly can be fixed in the display system, the assembly is provided with an optional fixing system comprising a double-sided adhesive tape 6 and a second release film 7, as a second temporary support, which is arranged on the side of the glass plate that is not covered over its full area by the 2D element; this side represents what will later be the outside of the display system. This double-sided adhesive tape 6 is covered, so as to protect against unintended bonding of the second release film 7, and in the present case is of backing-free design, in the form of an adhesive transfer tape, though it may also have a backing. The fixing system 6, 7 has a particular shape, so that it does not hide the optical sight path of the display, and in the present case is implemented in the form of a die cut. With the aid of the fixing system 6, 7, the assembly can be fixed via its glass plate 5 in the device that contains the display system. Joining to the LCD module that is used as a display device is achieved in this case via the casing of the device, to which both the LCD module and the assembly are fastened (indirect connection).

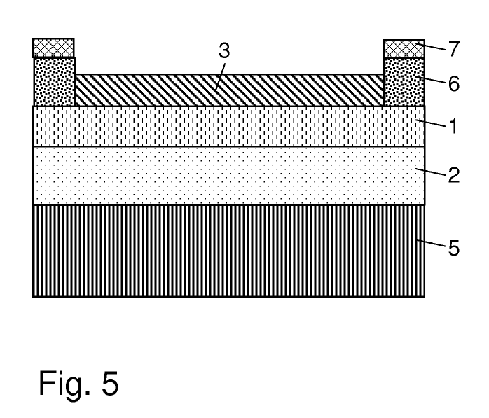

The second construction embodiment of the assembly element shown in FIG. 5, with a 2D element and a glass plate as see-through element 5, has as its 2D element a 2D element having the construction shown in FIG. 1; it is equally possible to use a 2D element having a different construction, such as the inverse construction shown in FIG. 2. In the case of the 2D element shown in FIG. 1, the release film 4 has been removed, to allow the element to be fixed flatly and without bubbles to the glass plate 5 by means of the pressure-sensitive adhesive 2. In order that the resulting assembly can be fixed in the display system, the assembly is provided with an optional fixing system comprising a double-sided adhesive tape 6 and a second release film 7, as a second temporary support. In contradistinction to the construction shown in FIG. 4, however, the fixing system in this case is provided not on what will later form the outside of the display system, but instead on its inside. For this purpose the adhesive tape 6 is joined directly to the support film 1 of the 2D element, so that the antireflection coating 3 is surrounded by the adhesive tape 6 in the two-dimensional arrangement. In this arrangement, then, the antireflection coating 3 does not cover the support film 1 over its full area, but only partially. Here as well, however, the entire viewing field of the subsequent display system is covered by the antireflection coating 3. By means of the fixing system 6, 7 it is possible for the assembly to be fastened, via its reverse side, to the casing of the device that contains the display system. Alternatively it is possible, in the case of this construction, to fix the assembly system directly to the outside of the display device. In that case it is advantageous for the adhesive tape to have a certain dimensional stability, in order to serve as a distancing piece or spacer between the surface of the assembly and the surface of the display device.

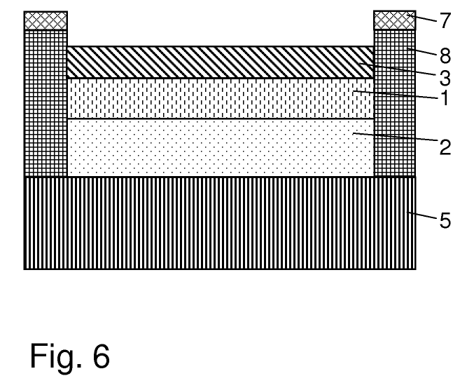

The third construction embodiment of the assembly element shown in FIG. 6, with a 2D element and a glass plate as see-through element 5, has as its 2D element a 2D element having the construction shown in FIG. 1; it is equally possible to use a 2D element having a different construction, such as the inverse construction shown in FIG. 2. In the case of the 2D element shown in FIG. 1, the release film 4 has been removed, to allow the element to be fixed flatly and without bubbles to the glass plate 5 by means of the pressure-sensitive adhesive 2. In order that the resulting assembly can be fixed in the display system, the assembly is provided with an optional fixing system comprising a double-sided adhesive tape 8 and a second release film 7, as a second temporary support. As in the case of the construction shown in FIG. 5, the fixing system 7, 8 is provided on the side of the assembly which will later form the inside of the display system. In contradistinction to the construction shown in FIG. 5, however, the fixing system is fixed not to the support film 1 but instead directly to the glass plate 5. In this arrangement, accordingly, the entire 2D element is surrounded by the fixing system 8 in the two-dimensional arrangement, with the consequence that, although the antireflection coating 3 covers the support film 1 over its full area, the 2D element only covers the glass plate 5 partially. With the aid of the fixing system 7, 8 the assembly can be fixed, by means of its reverse, to the casing of the device that contains the display system. In this case the adhesive tape 8 is designed as a foam-backed adhesive tape and in terms of height does not finish flush with the support 1. By this means it is possible to fasten the assembly directly to the display device, the use of the foam-backed adhesive tape keeping the surfaces of the support and of the display device at a distance from one another and at the same time producing a decoupling effect. Instead of this, this assembly can also be fixed on a casing frame.

Investigations of the transparency and bond strength of 2D elements were carried out on six different systems. To produce these six different 2D element systems, one of three adhesives investigated—polymers 1, 2 and 3 was applied to one of three supports—support A, support B and support C.

For the polymerization of polymer 1, a 2 l glass reactor typical for free-radical polymerizations was charged with 32 g of acrylic acid, 168 g of n-butyl acrylate and 200 g of 2-ethylhexyl acrylate in 300 g of a mixture of acetone and 2-propanol in a ratio of 97:3, the monomers having been freed from any stabilizer admixtures in a purification step prior to the reaction. The reaction mixture was freed from dissolved gases by passing nitrogen through it for forty-five minutes. To initiate the reaction, the reaction mixture was heated to a temperature of 58° C. and at that temperature was admixed with 0.2 g of 2,2′-azobis(2-methylbutyronitrile) (Vazo 67® from DuPont). Following the addition, the heating bath surrounding the reactor was heated to a temperature of 75° C. and the reaction was carried out constantly at the temperature subsequently established in the reactor. After a reaction time of 1 h a further 0.2 g of 2,2′-azobis(2-methylbutyronitrile) (Vazo 67® from DuPont) was added to the reaction mixture. After 3 h and again after 6 h, the reaction mixture was diluted with 150 g portions of the mixture of acetone and 2-propanol. To reduce the residues of initiator remaining in the reaction solution, 0.4 g portions of di(4-tert-butylcyclohexyl) peroxydicarbonate (Perkadox 16® from Akzo Nobel) were introduced into the reactor after 8 h and again after 10 h. After a total reaction time of 22 h, the reaction was discontinued by cooling of the reactor to room temperature.

The polymerization of the polymer 2 was conducted in exactly the same way as described for polymer 1, the difference from the synthesis of polymer 1 being that the reaction mixture contained—instead of 32 g of acrylic acid and 168 g of n-butyl acrylate—20 g of acrylic acid, 40 g of methyl acrylate and 140 g of n-butyl acrylate (these monomers as well had been freed from stabilizer admixtures prior to the reaction).

The resulting solutions of polymers 1 and 2 were each mixed with 0.3% by weight of aluminium(III) acetylacetonate, with stirring, and the resulting mixture was diluted with acetone to a solids content of 30%.

For the polymerization of a block copolymer (polymer 3) a mixture of a nitroxide and an alkoxyamine was used. The nitroxide used was 2,2,5-trimethyl-4-phenyl-3-azahexane 3-nitroxide (see structure below), prepared in accordance with a literature procedure (Journal of American Chemical Society, 1999, 121(16), 3904).

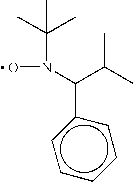

The alkoxyamine used was a difunctional alkoxyamine prepared in analogy to a synthesis procedure known from the literature (Journal of American Chemical Society, 1999, 121(16), 3904). The starting materials used in this procedure were 1,4-divinylbenzene and the above-described nitroxide. The resulting alkoxyamine had the following structure:

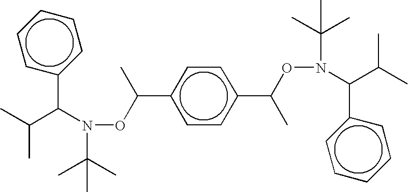

Polymer 3 was prepared using 0.739 g of the difunctional alkoxyamine and 0.0287 g of the free nitroxide as initiators, in a molar ratio of 10:1. These initiators were mixed with a mixture of 128 g of distilled isobornyl acrylate and 192 g of distilled 2-ethylhexyl acrylate, corresponding to the above-described monomers B of the subsequent polymer block P(B). The reaction mixture was degassed with repeated cooling to a temperature of −78° C. and then heated to a temperature of 110° C. under pressure in a closed pressurized reactor. After a reaction time of 36 h, 180 g of distilled o-methoxystyrene were added as a further monomer to the reaction mixture, corresponding to the above-described monomer A of the subsequent polymer block P(A), and the reaction mixture was held at this temperature for a further 24 h.

To end the reaction and isolate and work up the reaction product, the reaction mixture was cooled to room temperature, the resulting block copolymer was dissolved in 750 ml of dichloromethane and then this copolymer was precipitated from 6.0 l of methanol at a temperature of −78° C. and with vigorous stirring. The precipitate was separated from the supernatant by means of a cooled glass frit.

The product obtained was concentrated in a vacuum drying cabinet at 10 torr and 45° C. for a period of 12 h. The refractive index nd of the adhesive was determined in a standardized method in an Abbe refractometer from Kruss Optronic GmbH using light with a wavelength of 550 nm±150 nm for a film of adhesive with a thickness of 25 μm. The measuring cell was conditioned to 25° C. by operation thereof together with a Lauda thermostat. The refractive index of the adhesive was found to be 1.525. Support films were coated using a solution of the reaction product in toluene.

Support A used was a Reflex LT2 PET film from Cadillac Plastic with a thickness of 125 μm. The film was coated with one of the polymer compositions on the side face not made anti-reflective.

Support B used was a NCARC7 PET film from CP Films with a thickness of 125 μm. The film was coated with one of the polymer compositions on the side face not made anti-reflective.

Support C used was a Lumirror™ T60 PET film from Toray with a thickness of 50 μm. As an antireflection agent, the film was coated on one side with a sol-gel solution and dried at temperatures between 50° C. and 100° C., using a temperature programme with a temperature gradient.

The sol-gel solution used for the coating operation was obtained in a sol-gel process. For this purpose, in a vessel with an airtight seal that had a water-cooled condenser attachment, 122 ml of ethanol, 122 ml of tetraethoxysilane, 0.4 ml of 1 M hydrochloric acid and 9.6 ml of demineralized water were mixed with stirring, using an agitator mechanism, for a time of 90 minutes at a temperature of 60° C., after which the reaction mixture was cooled to a temperature of 40° C. This mixture was admixed with a solution of 17.4 g of aluminium sec-butoxide in 18 ml of 2-propanol and the resulting reaction mixture was stirred for a time of 10 minutes. Following the addition of 10 ml of demineralized water, the mixture was mixed with stirring for a further 10 minutes at a temperature of 40° C. Then 26.9 ml of trimethyl borate were added to the reaction mixture, and the mixture was stirred at a temperature of 40° C. for a period of 1 hour. After the reaction mixture had been cooled to 25° C., 25.8 ml of water, 8 ml of concentrated acetic acid, a further 25.8 ml of water and 10.8 ml of a 1 M barium acetate solution were added in succession and the mixture was stirred at a temperature of 25° C. for a time of 15 minutes. A portion of the resulting suspension was diluted with four times the volume of absolute ethanol, in the absence of atmospheric oxygen. The transparent suspension thus diluted was then stored at a temperature of 50° C. for 3 weeks, in order to allow equilibrating ageing processes to run their course. The sol-gel solution which formed was stirred up and liquefied in an ultrasound bath, diluted with ethanol and applied using a doctor blade to the PET film of support C. The PET film was then coated with the polymer composition on the side face that had not been coated with the sol-gel solution.

To produce the samples, a coating bar was used to apply a polymer, from solution, to the uncovered side of a support, and then the solvent was evaporated. The resulting 2D element was dried at a temperature of 120° C. for 10 minutes. The coat weight obtained after drying was 100 g/m2.

For sample 1A, polymer 1 was applied to support A; for sample 1B, polymer 1 was applied to support B; for sample 2A, polymer 2 was applied to support A; for sample 2B, polymer 2 was applied to support B; for sample 3C, polymer 3 was applied to support C; and for sample 3B, polymer 3 was applied to support B.

Described below first of all are a number of investigations of the properties which relate to the fundamental suitability of the samples as an optically transparent shatterproofing device. Reference is then made to further experiments, which indicate an additional effect of the 2D element of the invention.

The bond strength of the samples on a glass substrate (peel strength) was determined in a method based on PSTC 1. For this test, a strip of the 2D element with a width of 2 cm was applied to a glass plate in such a way that only one free end section of the strip was not in contact with the surface of the glass plate. The region of the adhesive strip in contact with the glass substrate was pressed onto the glass substrate using a roller with a mass of 2 kg, which was rolled over the bond three times, each rollover comprising two passes of the roller acting in opposite directions of advance.

For the actual measurement of the bond strength, the glass plate with the 2D element fixed in this way was fastened stationarily. The 2D element was fixed by its free end to a tensile testing machine and, 10 minutes after bonding had been effected (measurement of the instantaneous bond strength), was peeled using the tensile testing machine at a peel angle of 180° with a rate of advance of 300 mm/min. The maximum force at which the bond still did not part corresponds to the bond strength on the substrate in question; this bond strength is reported in N/cm.

The results are reproduced below in Table 1.

TABLE 1

| | Bond strength |
|---|---|
| | on glass |
| Sample | [N/cm] |
| 1A | 8.0 |
| 1B | 7.6 |
| 2A | 8.9 |
| 2B | 8.6 |
| 3C | 6.1 |
| 3B | 5.2 |

In Table 1 it is apparent that all of the samples exhibited a high bond strength on the glass substrate. As a consequence of this effective adhesion, therefore, all of the samples are suitable for adhesive bonds on glass.

For further investigation, the samples were applied in bubble-free form, using a rubber roller, to a glass plate of type D 263 T (borosilicate glass, 1.1 mm thick, from Schott, with a refractive index nd of 1.5231). The samples were pressed onto the glass substrate for a time of 10 s under a pressure of 40 N/cm2.

To examine the suitability of the sample as a shatterproofing device, the assembly comprising sample and glass substrate was subjected to a falling-ball test. For this purpose a section of the respective sample having a width of 4 cm and a length of 6 cm was fixed in bubble-free form as described above to a bonding surface. The assembly was stored for a time of 48 h at an ambient temperature of 23° C. and a relative humidity of 50% for the equilibration of the samples. For the implementation of the test itself, the mass of the assembly was determined by gravimetry and the assembly thereafter was fastened in a holder in such a way that the side face with the glass side at the top and the side face with the sample at the bottom were each aligned horizontally. To start with, at a distance of 1 m above the assembly, a steel ball with a mass of 63.7 g was fixed, and finally released by means of a trigger apparatus. After a height of fall of 1 m, the steel ball struck the glass side of the assembly. Following the impact, the mass of the assembly was redetermined by means of a balance. The falling-ball test was passed (and the sample therefore suitable as a shatterproofing device) if the difference in mass in the sample before and after the impact of the ball was less than 5% by weight (based on the total mass of the glass), with the inference that, overall, only a few of the glass splinters formed when the ball struck the assembly had parted from the assembly and from the adhesive bond.

The results of the falling-ball test are reproduced below in Table 2.

TABLE 2

| | Difference in mass |
|---|---|
| | [% by weight of the |
| Sample | glass mass] |
| 1A | <2 |
| 1B | <2 |
| 2A | <2 |
| 2B | <2 |
| 3C | <2 |
| 3B | <2 |

Table 2 reveals that in all of the samples, when the steel ball had impacted, only a few splinters passed out of the adhesive bond, with the consequence that all of the samples offer effective proof against shattering.

The transmittance of the samples was determined in a method according to ASTM D1003 for light with a wavelength of 550 nm. In this case as well, the samples were investigated in each case in the above-described assembly comprising the 2D element and the glass plate.

The results of the transmittance measurement are reproduced below in Table 3.

TABLE 3

| | Transmittance |
|---|---|
| Sample | [%] |
| 1A | 91 |
| 1B | 94 |
| 2A | 91 |
| 2B | 94 |
| 3C | 88 |
| 3B | 90 |

Table 3 reveals that all of the samples had a transmittance of more than 85% and were therefore of high transparency optically.

To investigate the suitability of the 2D element under long-term illumination, the light stability of the samples was investigated in the above-described assembly with a glass plate. For this purpose, the assembly described above, with a size of 4 cm×20 cm, was half-covered with an opaque cardboard plate. This half-covered assembly was subjected to exposure with the polychromatic light from an intense incandescent lamp (Osram Ultra Vitalux; 300 W, disposed in each case at a distance of 50 cm from the sample) in an illumination apparatus for a duration of 300 h, this being intended to simulate exposure of the sample to the light from a backlit display. After the end of light exposure, the plate was removed and the appearance of the illuminated sub-area was compared qualitatively with that of the unirradiated sub-area, particular attention being paid to any instances of discolouration. The sample was deemed light-stable if no discolouration was observed as a consequence of the illumination.

The results of the light stability test are reproduced below in Table 4.

TABLE 4

| Sample | Light stability |
|---|---|
| 1A | passed |
| 1B | passed |
| 2A | passed |
| 2B | passed |
| 3C | passed |
| 3B | passed |

As can be seen from Table 4, all of the samples had good light stability and high ageing stabilities. More particularly there were no instances of discolouration that might adversely effect the beam path of the transmitted light and hence might bring about any geometric distortion or colour change. Consequently all of the samples are also suitable for long-term applications.

The above experiments show that all of the samples are fundamentally suitable for use as optically transparent shatterproofing devices under realistic conditions.

In addition to the transmittance measurement described above, an investigation was made of the suitability of the 2D element of the invention as a protective film on a display array under realistic conditions as well, specifically on a liquid-crystal display device with a rectangular display area having a sight-field diagonal of approximately 5 cm (2.5 inch LCD display). For this purpose, a strip of a double-sided adhesive tape 2 mm wide was affixed to each of the four side margins of the liquid-crystal display device, as a fixing aid and spacer for the adhesively bonded assembly. In this case the following double-sided pressure-sensitive adhesive tapes were employed: tesa® 4972 (thickness: 48 μm), tesa® 4982 (thickness: 100 μm), tesa® 4965 (thickness: 205 μm), Mitsubishi RN (a PET film 250 μm thick, whose facing side and rear side were each laminated with a further film—tesa® 4982; total thickness: 450 μm) and tesa® 4952 (thickness: 1150 μm).

Samples of the 2D element of the invention were fixed to a borosilicate glass plate as described above, the samples being equipped with support B as film support, so producing samples 1B, 2B and 3B. The resulting assembly was bonded with the support film of the 2D elements to the liquid-crystal display device, in each case by means of the exposed adhesives of the double-sided adhesive tapes at the side margins of the liquid-crystal display device, thereby producing a different distance, depending on the specific double-sided adhesive tape selected, between the support of the 2D element and the surface of the display device. The overall arrangement for the adhesively bonded assembly, therefore, was that shown in FIG. 3.

For the actual test of the suitability of the 2D element, an image reproduced on the display area of the liquid-crystal display device was viewed through the adhesively bonded assembly and assessed as to its quality. The qualitative results obtained in this case for the different samples and the different adhesive spacer films are summarized in Table 5 below.

TABLE 5

| Spacing | | | |
|---|---|---|---|
| [μm] | Sample 1B | Sample 2B | Sample 3B |
| 48 | high transparency | high transparency | high transparency |
| | clear image | clear image | clear image |
| 100 | high transparency | high transparency | high transparency |
| | clear image | clear image | clear image |
| 205 | high transparency | high transparency | high transparency |
| | clear image | clear image | clear image |
| 450 | high transparency | high transparency | high transparency |
| | clear image | clear image | clear image |
| 1150 | reduced | reduced | reduced |
| | transparency slightly | transparency slightly | transparency slightly |
| | diffuse image | diffuse image | diffuse image |

As may be ascertained from Table 5, the transparency of the 2D element in the display system is high in the case of the samples investigated, for all spacings. It is particularly high for small average spacings between the surface of the LCD display and the surface of the support.

If the spacing becomes too great, the image shown on the display array loses clarity and has a slightly diffuse effect, as shown more particularly by the result obtained for a spacing of 1150 μm. Towards shorter spacings, the spacing is not limited on optical grounds. Instead it is necessary to observe a minimum spacing of 40 μm in order to prevent a situation where, in the case of mechanical effects acting on the glass plate, the glass plate, owing to its elastic deformation, comes into contact, via the 2D element, with the surface of the display device and causes damage to said device.

Accordingly the 2D element of the invention can be used with outstanding effect as a shatterproofing device of optically high transparency.

1. Exclusively unilaterally bondable, substantially two-dimensional element (2D element) comprising a sheetlike first functional layer, a sheetlike second functional layer and a sheetlike adhesive coating (2),
one of the two functional layers being designed as a support (1) and the other of the two functional layers being designed as an adapter (3),
the second functional layer having, parallel to its principal extent, first and second side faces,
the first functional layer being disposed on the first side face of the second functional layer, and
the adhesive coating (2) being disposed on the second side face of the second functional layer and being adapted for permanent joining of the 2D element to a brittle 2D body which is to be held together by means of the 2D element in the event of fracture,
wherein
the first functional layer has a refractive index n_{d}(20° C.) from a range from 1.20 to 1.40, preferably from a range from 1.23 to 1.37,
the second functional layer has a refractive index n_{d}(20° C.) from a range from 1.48 to 1.60, more preferably from a range from 1.53 to 1.59, and
the adhesive coating (2) has a refractive index n_{d}(20° C.) from a range from at least 1.43 to 1.60, preferably from a range from 1.47 to 1.58, more preferably from a range from 1.47 to 1.50.

2. The element according to claim 1, wherein the first functional layer is designed as an adapter (3) and the second functional layer is designed as a support (1).

3. The element according to claim 1, wherein the first functional layer is designed as a support (1) and the second functional layer is designed as an adapter (3).

4. The element according to claim 3, wherein the adapter (3) is an antireflection means set up to reduce the fraction of the visible light reflected at the outside of the 2D element.

5. The element according to claim 4, wherein the antireflection means has a multi-ply construction.

6. The element according to claim 4, wherein the antireflection means has a single-ply construction.

7. The element according to claim 6, wherein the antireflection means is an antireflection coating having a coat thickness of at least 0.2 nm and not more than 500 nm, preferably having a coat thickness of at least 1.0 nm and not more than 50 nm.

8. The element according to any one of claim 1, wherein the 2D element is designed so as to be of ultra-high transparency for visible light over its full area, having a transmittance for light with a wavelength of 550 nm of more than 86%, preferably of more than 88% and more preferably of more than 92%.

9. The element according to claim 1, wherein the first functional layer is designed to be stable to mechanical stress.

10. The element according to claim 1, wherein the adhesive coating (2) comprises a pressure-sensitive adhesive.

11. The element according to claim 1, wherein the 2D element comprises a temporary support (4), the temporary support (4) being disposed on the adhesive coating (2) and being residue-lessly detachably joined to the adhesive coating (2).

12. Method of using an element according to claim 1 as a shatterproofing device for a brittle 2D body, which, in the event of fracture of the 2D body, holds the 2D body at least substantially together and so acts against separation of fragments of the 2D body.

13. An sdhesively bonded assembly comprising a 2D element according to claim 1 and a see-through element (5), wherein the see-through element (5) is permanently joined to the 2D element via the adhesive coating (2) of the 2D element.

14. An adhesively bonded assembly according to claim 13, wherein the see-through element (5) has at least one glass portion which, as a brittle 2D body, is adapted for joining to the 2D element.

15. A method of using an adhesively bonded assembly according to claim 13 as a damage protection device for a display device, which acts against damage to the display device in the event of external mechanical influence.

16. A display system having an adhesively bonded assembly according to claim 13 and a display device, wherein the adhesively bonded assembly is disposed in the display system in such a way that the side of the adhesively bonded assembly on which the 2D element is disposed is facing the side of the display device that is adapted for the display of the information to be displayed.

17. A display system according to claim 16, wherein the 2D element and the side of the display device that is adapted for the display of information are disposed at a distance from one another such that the average distance is at least 40 μm and not more than 510 μm, more particularly at least 50 μm and not more than 400 μm.
